(19) United States
(12) Patent Application Publication
(10) Pub. No.: US 2014/0301262 A1
(43) Pub. Date: Oct. 9, 2014

(54) IN-SUBFRAME ADAPTIVE ADJUSTING

(71) Applicant: QUALCOMM Incorporated, San Diego, CA (US)

(72) Inventors: Sandip Homchaudhuri, San Jose, CA (US); Ali Raissinia, Monte Sereno, CA (US); Brian Clarke Banister, San Diego, CA (US); Alexei Yurievitch Gorokhov, San Diego, CA (US)

(73) Assignee: QUALCOMM Incorporated, San Diego, CA (US)

(21) Appl. No.: 14/074,455

(22) Filed: Nov. 7, 2013

Related U.S. Application Data
(63) Continuation-in-part of application No. 13/954,035, filed on Jul. 30, 2013.
(60) Provisional application No. 61/809,257, filed on Apr. 5, 2013.

(51) Int. Cl. H04W 52/02

(52) U.S. Cl. CPC H04W 52/0235
USPC 370/311

(57) ABSTRACT

Methods, apparatuses, systems, and devices are described for wireless communication. In one configuration, an allocation of physical resources to be utilized by a wireless communication device during one or more portions of a subframe may be received at the wireless communication device. There may then be determined, based on the received allocation of physical resources, one or more bandwidths to be utilized at the wireless communication device during the one or more portions of the subframe. At least one of a voltage level or a clock frequency of the wireless communication device may be adjusted to process the one or more portions of the subframe. The at least one of the voltage level or the clock frequency may be adjusted based on the determined one or more bandwidths.

### CROSS-REFERENCES

The present application for patent is a Continuation-in-Part of and claims priority to co-pending U.S. patent application Ser. No. 13/954,035, entitled “DYNAMIC VOLTAGE AND FREQUENCY SCALING IN WIRELESS MODEMS” by Homchaudhuri et al., filed Jul. 30, 2013, which claims priority to co-pending U.S. Provisional Patent Application No. 61/809,257, entitled “DYNAMIC VOLTAGE AND FREQUENCY SCALING IN WIRELESS MODEMS” by Homchaudhuri et al., filed Apr. 5, 2013, both assigned to the assignee hereof, and expressly incorporated by reference herein.

### BACKGROUND

Wireless communications networks are widely deployed to provide various communication services such as voice, video, packet data, messaging, broadcast, and the like. These wireless networks may be multiple-access networks capable of supporting multiple users by sharing the available network resources.

A wireless communication network may include a number of network devices such as access points (APs) and/or base stations that can support communication for a number of wireless devices. A wireless device may communicate with a network device bidirectionally. For example, in cellular networks, a user equipment (UE) may communicate with a base station via downlink and uplink. The downlink (or forward link) refers to the communication link from the base station to the UE, and the uplink (or reverse link) refers to the communication link from the UE to the base station.

The operational system bandwidth between a base station and a UE, on a downlink or uplink, may be pre-configured by a wireless communication network. In many cases, certain transmissions, such as control channel signaling, occupy the entire operational system bandwidth. Even though other types of transmissions may occupy a smaller portion of the operational system bandwidth, the wireless device may process all transmissions using the same resources as the wider bandwidth transmissions.

### SUMMARY

The described features generally relate to one or more improved methods, apparatuses, systems, and/or devices for wireless communication. Although the operational system bandwidth between a base station or eNodeB and a UE may be a wide band, and most or all of the resources in the wide band may be used for some transmissions, only a subset of the available resources may be allocated for other transmissions. In cases where the resources allocated to a particular transmission occupy a more narrow band, the voltage level and/or clock frequency used to process the transmissions may be adjusted (e.g., scaled) to a lower voltage level or clock frequency, thereby saving power.

In a first set of illustrative embodiments, a method for wireless communication is described. In one configuration, an allocation of physical resources to be utilized by a wireless communication device during one or more portions of a subframe may be received at the wireless communication device. There may then be determined, based on the received allocation of physical resources, one or more bandwidths to be utilized at the wireless communication device during the one or more portions of the subframe. At least one of a voltage level and/or a clock frequency of the wireless communication device may be adjusted to process the one or more portions of the subframe. The at least one of the voltage level and/or the clock frequency may be adjusted based on the determined one or more bandwidths.

In some examples, the allocation of physical resources may include an uplink grant, and the method may further include transmitting data during the one or more portions of the subframe while operating at the at least one of adjusted voltage level or clock frequency. The method may also include receiving data during the one or more portions of the subframe while operating at the at least one of adjusted voltage level or clock frequency, and processing data received during the one or more portions of the subframe at the at least one of adjusted voltage level or clock frequency.

In some embodiments, the method may include reconfiguring at least one of an analog front-end filter or a digital filter of the wireless communication device based on the received allocation of physical resources to be utilized by the wireless communication device during the one or more portions of the subframe. In these embodiments, reconfiguring the analog front-end filter may include changing a center frequency and bandwidth of the analog front-end filter based on the received allocation of physical resources to be utilized by the wireless communication device during the one or more portions of the subframe, and/or reconfiguring the digital filter may include changing a bandwidth and down-mixing of the digital filter based on the received allocation of physical resources to be utilized by the wireless communication device during the one or more portions of the subframe. Also in these embodiments, the method may further include receiving a control region of the subframe while operating the wireless communication device at a wideband mode across a system bandwidth defined for the subframe. Reconfiguration of the analog front-end filter or the digital filter may occur between the control region of the subframe and the one or more portions of the subframe, and/or the allocation of physical resources to be utilized by the wireless communication device during the one or more portions of the subframe may be received over the control region of the subframe.

Based on the received allocation of physical resources to be utilized by the wireless communication device during the one or more portions of the subframe, at least one of an analog domain clock, a digital domain clock, a sampling rate, or a size of a discrete Fourier transform or an inverse discrete Fourier transform utilized by the wireless communication device may be adjusted to process the one or more portions of the subframe.

In some cases, the method may further include applying the adjusted voltage level to at least one of an analog front-end of the wireless communication device or a digital signal processing component of the wireless communication device. The digital signal processing component of the wireless communication device may include at least one of: a digital filter, a discrete Fourier transform component of the wireless communication device, an inverse discrete Fourier transform component of the wireless communication device, a digital signal processor of the wireless communication device, or a hardware accelerator.

In some cases, receiving the allocation of physical resources to be utilized by the wireless communication device during the one or more portions of the subframe may include receiving an identification of a number of physical resource blocks allocated to the wireless communication device, and/or determining the one or more bandwidths to be utilized at the wireless communication device during the one or more portions of the subframe may include adjusting a minimum bandwidth associated with the number of physical resource blocks allocated to the wireless communication device by a bandwidth adjusting factor.

In some embodiments, the voltage level of the wireless communication device may be adjusted during a measurement gap based on a bandwidth to be utilized at the wireless communication device during the measurement gap.

In a second set of illustrative embodiments, a wireless communication device apparatus is described. In one configuration, the apparatus may include at least one processor and a memory communicatively coupled with the at least one processor. The memory may store instructions configured to cause the at least one processor to receive an allocation of physical resources to be utilized by the wireless communication device apparatus during one or more portions of a subframe; to determine one or more bandwidths to be utilized at the wireless communication device apparatus during the one or more portions of the subframe based on the received allocation of physical resources; and to adjust at least one of a voltage level or a clock frequency of the wireless communication device apparatus to process the one or more portions of the subframe. The at least one of the voltage level and/or the clock frequency may be adjusted based on the determined one or more bandwidths. In certain examples, the instructions may be further configured to cause the at least one processor to implement one or more aspects of the method for wireless communication described above with respect to the first set of illustrative embodiments.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram that illustrates an example of a wireless communications system according to various embodiments;

FIG. 2 shows a block diagram that illustrates an example of a wireless modem architecture according to various embodiments;

FIG. 3 is a time-frequency diagram showing various portions of a plurality of subframes in accordance with various aspects of the present disclosure;

FIG. 4 shows a diagram that illustrates an example of a frame structure that may be used in a wireless communication system in accordance with various aspects of the present disclosure;

FIG. 5 shows a diagram of an example allocation of physical resources in a subframe, in accordance with various aspects of the present disclosure;

FIG. 6A is a time-voltage diagram showing a voltage level used to process first, second, and third portions of a subframe in accordance with various aspects of the present disclosure;

FIG. 6B is a time-voltage diagram showing a voltage level used to process first, second, and third portions of a subframe in accordance with various aspects of the present disclosure;

FIG. 7A shows a diagram in which a frame sequence illustrates various aspects of dynamic voltage and/or frequency adjusting during measurement gaps in accordance with various aspects of the present disclosure;

FIG. 7B illustrates an example subframe with various options for ePDCCH, in accordance with various aspects of the present disclosure;

FIG. 8 shows a diagram UE configured for dynamic voltage and frequency adjusting in accordance with various aspects of the present disclosure;

FIG. 9A shows a first diagram of a transceiver module, in accordance with various aspects of the present disclosure;

FIG. 9B shows a second diagram of a transceiver module, in accordance with various aspects of the present disclosure;

FIG. 10A shows a third diagram of a transceiver module in accordance with various aspects of the present disclosure;

FIG. 10B shows a second diagram of a transceiver module in accordance with various aspects of the present disclosure;

FIG. 11A shows a diagram of a device where each of the components is included in an independent voltage domain, in accordance with various aspects of the present disclosure;

FIG. 11B shows a diagram that illustrates an example of a device where each of the components is included in an independent domain in accordance with various aspects of the present disclosure;

FIG. 12A illustrates a device in which the voltages for a digital baseband (BB) processor, a media access controller (MAC), and a System-on-Chip (SOC) are being adjusted indirectly and independently by different switched-mode power supplies (SMPSs), through low dropout voltage regulators (LDOs);

FIG. 12B illustrates a device in which the voltages for a BB, a MAC, and a System-on-Chip (SOC) are being adjusted indirectly and independently by different SMPSs, through LDOs;

FIG. 13 is a block diagram of a multiple-input multiple-output (MIMO) communication system including a base station and a UE;

FIG. 14 shows a flowchart diagram of an example method for wireless communication in accordance with various aspects of the present disclosure;

FIG. 15 shows a flowchart diagram of an example method for wireless communication in accordance with various aspects of the present disclosure;

FIG. 16 shows a flowchart diagram of an example method for wireless communication in accordance with various aspects of the present disclosure;

FIG. 17 shows a flowchart diagram of an example method for wireless communication in accordance with various aspects of the present disclosure; and

FIG. 18 shows a flowchart diagram of an example method for wireless communication in accordance with various aspects of the present disclosure.

### DETAILED DESCRIPTION

The present description relates to adaptive adjusting, for example, the use of dynamic voltage and/or frequency adjusting (DVFS) to save power when processing data received at, or transmitted from, a wireless communication device. A user equipment (UE) may use a certain sampling rate, voltage level, and Fast Fourier Transform (FFT) size to decode a wide band control channel at the beginning of a subframe, then carry over that same sampling rate, voltage level, and/or FFT size to decode or transmit data for narrower band shared channel stages of that same subframe.

However, because 1) the physical resources allocated to the UE in the shared channel stages typically do not occupy the entire operational system bandwidth, and 2) the locations of the allocated physical resources are identified in the time-frequency domain during the control channel decoding stage, it may be possible to save power by exploiting the knowledge of the allocated physical resources received in the control channel decoding stage to determine a more precise bandwidth for processing the shared channel stage of a subframe. Using this bandwidth, the UE may then dynamically adjust the voltage level, clock frequency, and/or FFT/IFFT size used to process the shared channel stage within the same subframe based on.

A voltage level may be identified that corresponds to the determined bandwidth and a processing voltage may be adjusted to the identified voltage level. For example, a higher bandwidth may use a higher voltage level and a lower bandwidth may use a lower voltage level. Additionally, a higher voltage level may allow for higher clock frequencies for digital processing.

The wireless communications device may be configured to operate in any wireless network such as, but not limited to a cellular network (e.g., LTE). When the device is operated in a cellular network, the voltage adjusting (e.g., and corresponding digital clock frequency adjusting) may be determined based on uplink (UL) and downlink (DL) scheduling conditions. For example, an in-frame or within frame detection scheme may be used to determine whether the wireless communications device is scheduled to receive or transmit information to a base station. In some cases, the operating voltage level may be reduced until a scheduled reception or transmission is scheduled to take place.

Techniques described herein may be used for various wireless communications systems such as cellular wireless systems, Peer-to-Peer wireless communications, WLANs, ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). LTE and LTE-Advanced (LTE-A) are new releases of UMTS that use E-UTRA. UTRA, E-UTRA, UMTS, LTE, LTE-A, and GSM are described in documents from an organization named 3GPP or “3rd Generation Partnership Project.” CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

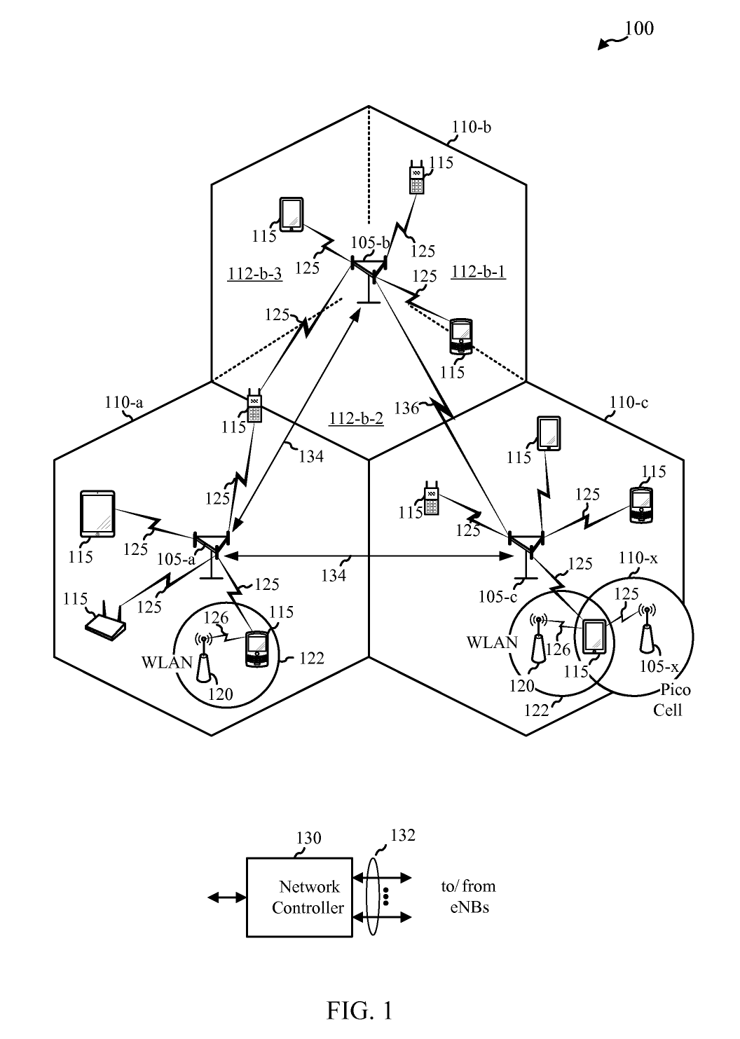

FIG. 1 shows a wireless network 100 for communication, which may include an LTE/LTE-A network and, in some cases, a wireless network such as a WLAN. It should be noted that while the example illustrates use of an LTE-A network and WLAN, any of various wireless networks may be used, as previously mentioned. The wireless network 100 includes a number of base stations 105 and other network entities or devices. A base station 105 may be a station that communicates with the UEs and may also be referred to as an eNodeB (eNB), an access point, or the like. Each base station 105 may provide communication coverage for a particular geographic area. In 3GPP, the term “cell” can refer to a particular geographic coverage area of a base station and/or a base station subsystem serving the coverage area, depending on the context in which the term is used.

A base station may provide communication coverage for a macro cell, a pico cell, a femto cell, and/or other types of cells. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, the base stations 105-a, 105-b, and 105-c are macro eNBs for the macro cells 110-a, 110-b, and 110-c, respectively. The base station 105-x is a pico eNB for the pico cell 110-x. A femto eNB is not shown but may be included in the wireless network 100. An eNB may support one or multiple (e.g., two, three, four, and the like) cells. Together the eNBs, pico eNB, and femto eNBs (not shown) may be referred to as eNBs (or base stations 105) in this disclosure.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

A network controller 130 may couple to a set of eNBs and provide coordination and control for these eNBs. The network controller 130 may communicate with the base stations 105 via a backhaul 132. The base stations 105 may also communicate with one another, e.g., directly or indirectly via a wireline backhaul 134 or a wireless backhaul 136.

User equipments (UEs) 115 may be dispersed throughout the wireless network 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The wireless network 100 shows transmissions 125 between UEs 115 and base stations 105. The transmissions 125 may include uplink (UL) and/or reverse link transmission, from a UE 115 to a base station 105, and/or downlink (DL) and/or forward link transmissions, from a base station 105 to a UE 115. LTE/LTE-A utilizes OFDMA on the downlink and SC-FDMA on the uplink. OFDMA and SC-FDMA partition the system bandwidth into multiple (K) orthogonal subcarriers, which are also commonly referred to as tones, bins, or the like. Each subcarrier may be modulated with data. The spacing between adjacent subcarriers may be fixed, and the total number of subcarriers (K) may be dependent on the system bandwidth. The system bandwidths may be 1.25, 2.5, 5, 10 or 20 MHz, for example. For these bandwidths, corresponding Fast Fourier Transforms (FFTs) of 128, 256, 512, 1024 or 2048 points may be used to process data. The system bandwidth may also be partitioned into sub-bands. For example, a sub-band may cover 1.08 MHz, and there may be 1, 2, 4, 8 or 16 sub-bands for a corresponding system bandwidth of 1.25, 2.5, 5, 10 or 20 MHz, respectively.

Also shown in FIG. 1 are two access points (APs) 120, where the first is connected to a UE 115 (e.g., STA) in cell 110-a and the second is connected to another UE 115 (e.g., STA) in cell 110-c. The UEs may communicate with the access points through transmissions 126. In this example, the UEs connected to the APs 120 may be dual mode devices that support communication with both a cellular network and WLAN. Each of the APs 120 has a coverage area 122 and may support one or more protocols described in the various IEEE 802.11 standards.

Each UE 115 may receive an allocation of uplink or downlink physical resources from a serving base station 105. This allocation of physical resources may define the times and frequencies on which the UE 115 is to listen for downlink transmissions from the eNB(s) 105 and/or transmit uplink transmissions to the base station(s) 105. Because the frequencies allocated to a UE 115 may vary on a subframe by subframe basis, the bandwidth of the allocated resources may also vary. Because the allocated resources for a subframe may be known by the UE 115 beforehand via control signaling, however, the UE 115 may transition from a wide band mode used to decode the control signaling at the beginning of a subframe to a narrower band mode adapted to process the resources allocated to the UE 115 for that subframe. The narrower band mode may include a lower operating voltage, sampling clock frequency, and/or FFT/IFFT size than are used during the wider band mode. Consequently, the in-subframe transition to the narrower mode may result in power savings by the UE 115, thereby prolonging battery life and conserving resources.

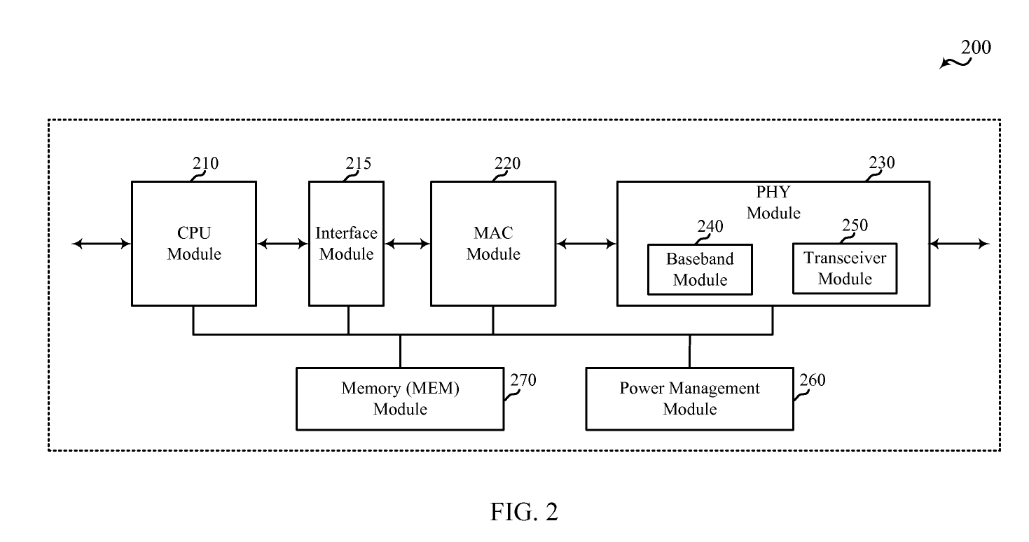

FIG. 2 shows a device 200 that may be part of a wireless modem. The device 200 may in some cases be implemented in conjunction with one of the UEs 115 described with reference to FIG. 1. The device 200 may be a cellular modem used for cellular communications. The device 200 may also be a processor. The device 200 may include a central processing unit (CPU) module 210, an interface module 215, a MAC layer module 220 (or simply MAC module 220), a PHY layer module (or simply PHY module 230), a power management module 260, and a memory (MEM) module 270. The PHY module 230 may include a baseband module 240 and a transceiver module 250. Each of these components may be in communication with each other.

The components of the device 200 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The CPU module 210 may be configured to provide higher level processing of data and/or control information. The CPU module 210 may, in some cases, include one or more processors, microcontrollers, and/or like devices, some of which may be based on an advance microcontroller bus architecture (AMBA), for example.

The interface module 215 may be configured to include a peripheral component interconnect express (PCIE)/universal serial bus (USB)/secure digital input output (SDIO) bridge for the data pipe between the CPU module 210 and the MAC module 220.

The MAC module 220 may be configured to provide an interface between a data link layer (layer 2 in the Open Systems Interconnection (OSI) model) and the network's physical layer (e.g., PHY module 230). The MAC module 220 may, in some cases, be referred to as a media access controller.

The PHY module 230 may be configured to provide an interface between the MAC module 220 and the physical medium (not shown). In LTE UEs, for example, the PHY module 230 operations may include radio frequency (RF) operations, mixed-signal and analog portions of PHY layer processing, and digital baseband (BB) processing. The digital baseband processing may be handled by, for example, a digital signal processor (DSP) in the baseband module 240. The RF operations and mixed-signal and analog portions of PHY layer processing may be part of the transceiver module 250. The transceiver module 250 may be configured to wirelessly transmit and/or receive frames or packets.

The power management module 260 may be configured to control or adjust the power (e.g., voltage, clock frequency) used in one or more of the components of the device 200. For example, the power management module 260 may adjust the Vdd used by the device 200. Vdd refers to the voltage regulator voltage used in integrated circuit architectures. Other terms may be used to refer to the voltage regulator voltage. Adjusting the voltage regulator voltage of a component of the device 200 may result in a corresponding adjustment of the clock frequency used by that component. The power management module 260 may be configured to implement some or all of the techniques described herein for dynamic voltage and frequency adjusting. In some cases, the power management module 260 may be part of a power management unit (PMU) and/or a power management integrated circuit (PMIC), for example.

The memory module 270 may be configured to store data associated with various aspects of the operation of the device 200, including initiation/configuration data, intermediate/processing data, software, firmware, and the like.

For an LTE modem (e.g., UE 115 modem or device 200 modem), the downlink scheduling control information (DCI) messages in a physical downlink control channel (PDCCH) may need to be decoded every 1 millisecond (ms). The scheduling information may indicate that a downlink (DL) or uplink (UL) grant may or may not have been provided to the UE by the eNB. When a DL grant is not provided, it may be sub-optimal to clock the LTE modem at highest clock frequency or at Vdd for the remainder of the subframe. Furthermore, when a UL grant is provided, it may still be sub-optimal to process the remainder of the sub-frame at the highest clock and voltage since the UE needs to act 4 ms later. A similar issue may arise with respect to the long and short discontinuous reception (DRX) intervals and measurement gaps used in LTE.

Additional details on how to implement dynamic voltage and/or frequency adjusting (e.g., in a subframe) in an LTE modem are described below with respect to various embodiments.

The various modes described herein have been provided by way of illustration and not of limitation. A wireless modem or other similar or like device may use more, fewer, and/or different modes without departing from the various aspects presented in the disclosure related to dynamic voltage and/or frequency adjusting.

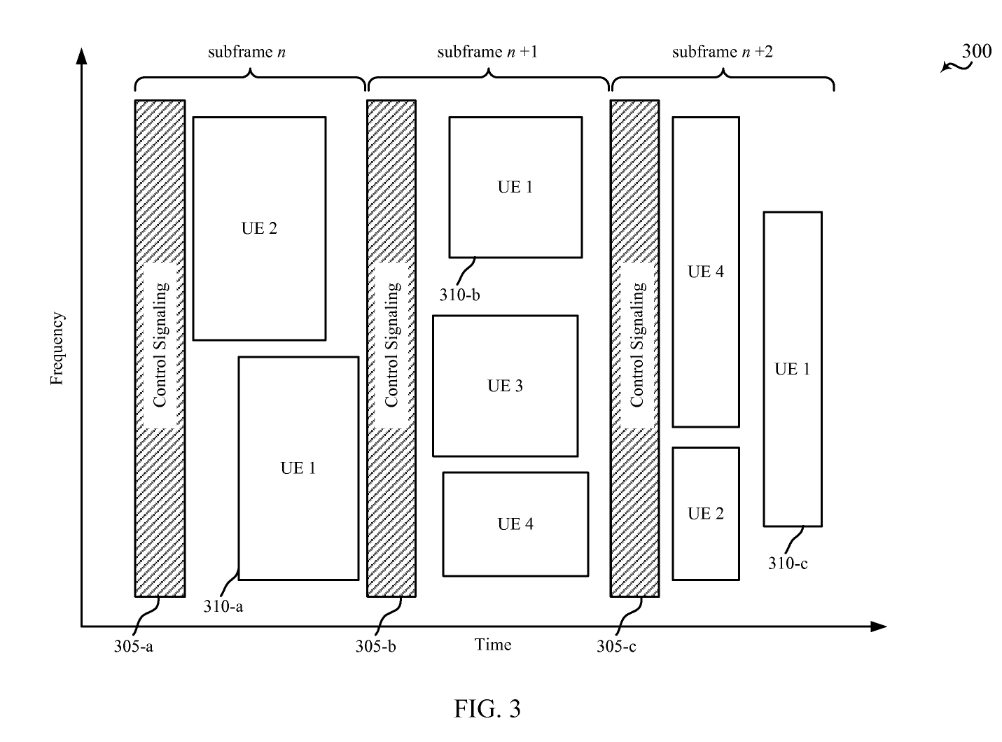

FIG. 3 is a time-frequency diagram 300 showing various portions 305-a, 305-b, 305-c, 310-a, 310-b, and 310-c of a plurality of subframes n, n+1, and n+2. The portions 305 may include control regions 305 and other portions 310 corresponding to various physical resource allocations received by UEs 115. The extents of at least the portions 310 may vary from one subframe to another, and from one portion of a subframe to another. The portions 305 and 310 may occupy different time windows and use different bandwidths. The portions 305 and 310 may differ in terms of both number of frequency subcarriers occupied and the center frequency of the frequency subcarriers occupied. For example portions UE 1 and UE 2 in subframe n have similar numbers of frequency subcarriers, but have very different center frequencies. The portions UE 1 and UE 2 in subframe n also occupy different (but overlapping) time windows.

Some of the portions shown in FIG. 3 (e.g., the control regions 305-a, 305-b, and 305-c of the subframe n, n+1, and n+2) occupy the entire available bandwidth, whereas other portions (e.g., those labeled UE 1, UE 2, UE 3, and UE 4) occupy only a part of the available bandwidth.

Physical resource allocations for the portions UE 1, UE 2, UE 3, and UE 4 may be received by a UE 115 within the control regions 305-a, 305-b, and 305-c. Upon receiving the physical resource allocations, the UE 115 may determine one or more bandwidths to be utilized during the one or more portions. The UE 115 may then adjust (e.g., scale) at least one of a voltage level or a clock frequency to process the one or more portions of the subframes, based on the determined one or more bandwidths. In this manner, a lower voltage level and/or a lower clock frequency may be used to process some of the portions 310, thereby conserving the UE's power.

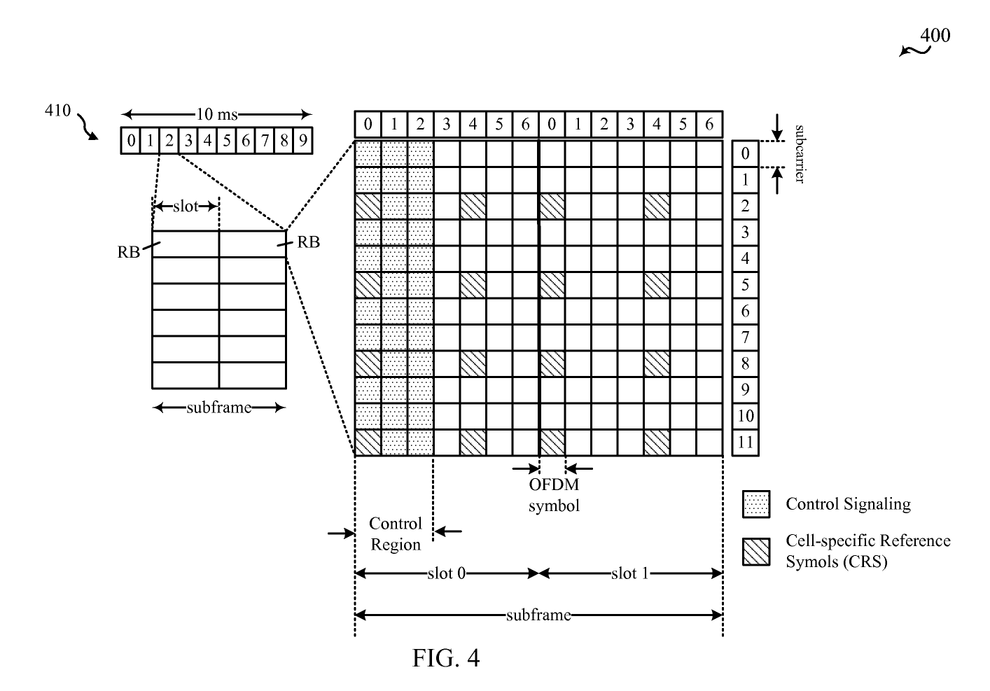

FIG. 4 shows a diagram 400 that illustrates an example of a frame structure that may be used in a wireless communication system, including the wireless communication system described above with reference to FIG. 1. The frame structure may be used in LTE or similar systems. A frame (10 ms) 410 may be divided into 10 equally sized sub-frames. Each sub-frame may include two consecutive time slots. A resource grid may be used to represent two time slots, each time slot including a resource block (RB). The resource grid may be divided into multiple resource elements.

In LTE, a resource block may contain 12 consecutive subcarriers in the frequency domain and, for a normal cyclic prefix in each OFDM symbol, 7 consecutive OFDM symbols in the time domain, or 84 resource elements. The number of bits carried by each resource element may depend on the modulation scheme. Thus, the more resource blocks that a UE receives and the higher the modulation scheme, the higher the data rate may be for the UE.

In this example, the first 1-3 or 1-4 OFDM symbols in the first slot may be used as a control region that includes control signaling symbols (dotted) and cell-specific reference symbols (CRS) (diagonal lines). The CRS may also be included in the remaining portion of the first slot and in the second slot. Control information provided in the control signaling symbols may include control information for one or multiple UEs contained in downlink control information (DCI) messages transmitted through physical downlink control channel (PDCCH).

Dynamic voltage and/or frequency adjusting may be implemented in connection with the decoding stage of PDCCH. For example, each PDCCH or control region (e.g., first 3 or 4 OFDM symbols) may need to be decoded at a 1 ms periodicity. A UE (e.g., UE 115), however, may or may not have downlink (DL) or reception grant or an uplink (UL) or transmission grant given to it. Because such grant may not be provided for a portion of the sub-frame, the remaining 11 or 10 OFDM symbols in the sub-frame may be ignored (e.g., not processed). When a DCI UL/DL grant is offered to the UE through the PDCCH, the UE may receive information about the resource block (RB) associated with the grants. The DL RB may be in the next slot, in which case the UE time may have between 3 and 4 OFDM symbols in the first slot to scale the clock and/or the voltage down before it needs to ready for the assigned DL grant.

When the grant is an UL grant, for example, which may be determined by decoding the first one to three or four OFDM symbols, the UE may ignore the remainder of the first slot and may clock gate with power adjusting (e.g., reduced Vdd, reduced clock) the second slot of the sub-frame. The UL typically takes place four sub-frames after the grant. For the next PDCCH, which occurs in the next sub-frame 1 ms later, the UE may get the clock back up for decoding the PDCCH control information, which may provide a DL grant (for that sub-frame) or another UL grant 4 ms later.

When the grant is a DL grant in the same sub-frame as the 1-3 or 1-4 OFDM symbols from which the grant is determined, the UE may ignore the remaining OFDM symbols in the first slot and may operate during the first slot at a reduced Vdd (e.g., and corresponding lower clock). For the second slot, the UE may increase the Vdd (e.g., and the clock) back up to handle the DL.

Because each OFDM symbol has a duration of approximately 71 μs, implementing dynamic voltage and/or frequency adjusting as described above for LTE slots and sub-frames may provide a significant amount of power savings in the operation of a wireless modem in a UE.

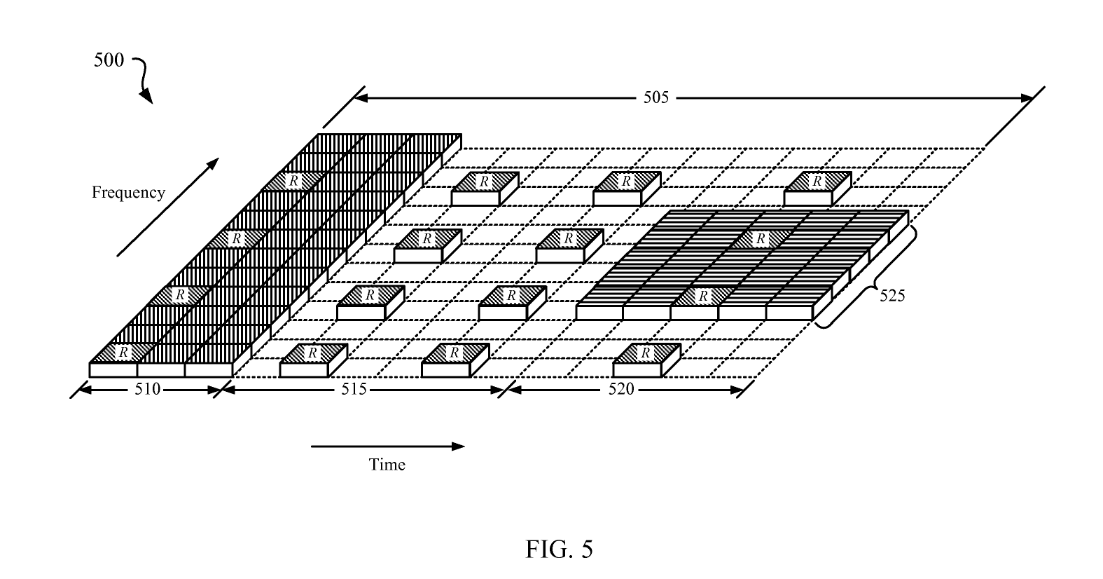

FIG. 5 shows a diagram 500 of an example allocation of physical resources in a subframe 505. The subframe 505 has a first portion 510 corresponding to a control region, a second portion 515 corresponding to one or more synchronization signals, and a third portion 520 corresponding to an allocation of physical resources (e.g., voltage, clock bandwidth, and other resources) specified in an uplink grant (e.g., for data to be transmitted) or a downlink grant (e.g., for data to be received).

The signaling utilized in the first portion 510 of the subframe 505 may occupy all, or substantially all, of the bandwidth of the portion 510. As a result, a UE 115 may process the first portion 510 in a wideband mode across a system bandwidth defined by the subframe 505. When processing the first portion 510, the UE 115 may identify an uplink grant or a downlink grant. The uplink grant or downlink grant may provide an allocation of physical resources to be utilized for transmitting or receiving data during the third portion 520 of the subframe 505.

As shown in FIG. 5, the allocated physical resources in the third portion 520 of the subframe 505 may occupy a bandwidth 525 that includes only a subset of the subcarriers of the subframe 505. A UE 115 may therefore adjust a voltage level and/or a clock frequency to process the third portion 520 of the subframe 505 and operate in a narrow band when transmitting or receiving data in the narrow band. In some cases, the voltage level and/or clock frequency may be adjusted (e.g., scaled) during the second portion 515 of the subframe 505.

Of note, the resource elements labeled “R” (e.g., reference symbols) may be provided for synchronization purposes and do not need to be factored into the bandwidth determination made for the allocation of resources in the third portion 520.

Any channel estimation that may be performed with reference symbols over the entire operational system bandwidth may be disadvantaged by the use of DVFS, given that only the reference symbols present within the allocation of physical resources may be processed for channel estimation. However, reference symbols located farther from an allocation of physical resources likely contribute less to channel estimation over the allocated physical resources. As such, DVFS may be performed over a group of subcarriers around an allocation of physical resources, with the group of subcarriers ascertained based on a reference symbol interpolation algorithm. The size of the group of subcarriers may be increased or decreased depending on a decoding success rate based on previous decoding attempts using smaller groups of subcarriers.

Channel quality information (CQI) reporting may not be required at all times and may be configured as periodic or aperiodic by a radio resource controller (RRC). As such, if CQI reporting is required during a portion of a subframe, DVFS may be disabled during that portion to provide a wideband CQI report.

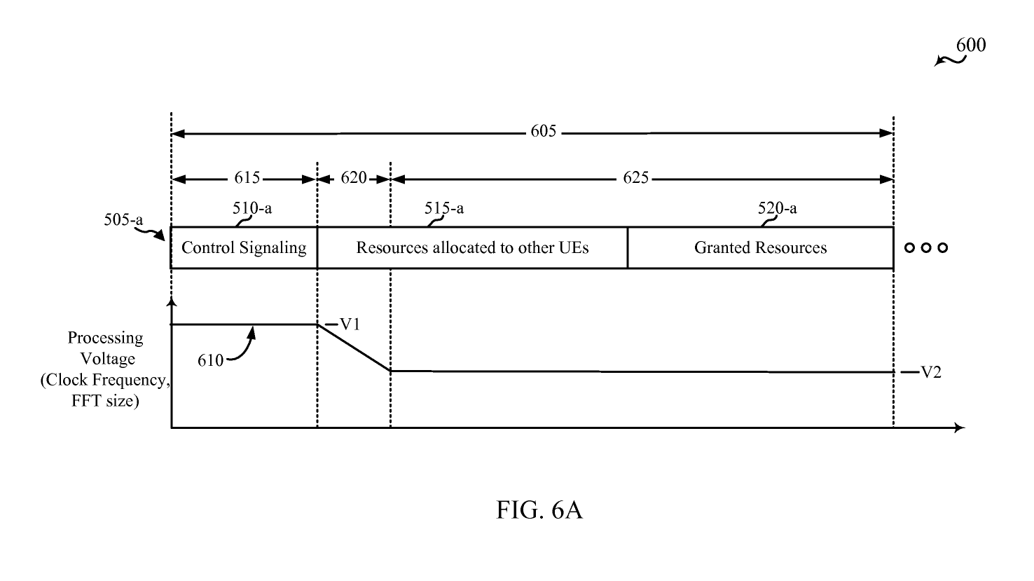

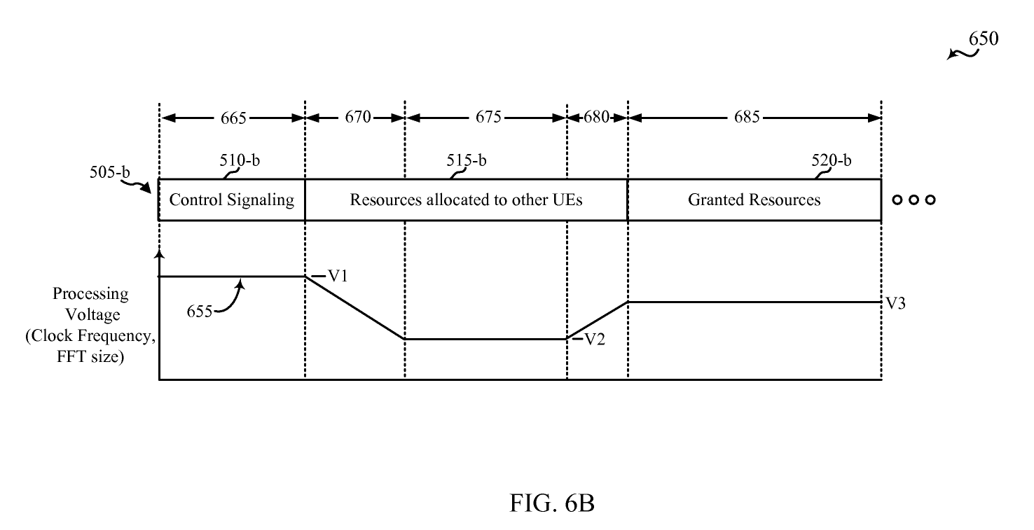

FIG. 6A is a time-voltage diagram 600 showing a voltage level used to process first, second, and third portions 510-a, 515-a, and 520-a of a subframe 505-a. In some embodiments, the first, second, and third portions 510-a, 515-a, and 520-a may be examples of the first, second, and third portions 510, 515, and 520 of the subframe 505 described with reference to FIG. 5.

The first portion 510-a of the subframe 505-a may include control signaling; the second portion 515-a may include resources allocated to a same or another UE 115; and the third portion 520-a may include an allocation of physical resources identified, for example, in an uplink grant or a downlink grant.

A UE 115 may process data that is both within the first portion 510-a of the subframe 505-a and within a region 615 using a clock or other resource having a voltage level V1. The clock may have a first frequency. The voltage level V1 may in some cases be used in a wideband mode of operation, and may be a maximum voltage level used to process received or transmitted data by the UE 115.

Within a region 620, the UE 115 may transition from the voltage level V1 to a voltage level V2. The voltage level V2 may be used to process data within the region 625 and the third portion 520-a. The voltage level V2 may in some cases be used in a narrowband mode of operation, and may be adjusted to a lower level than V1 based on the allocation of resources to be utilized in the third portion 520-a of the subframe 505-a. Associated with V2 may be an adjusted clock frequency and/or bandwidth. The voltage level 610 of a processing voltage and/or clock may thus follow the trend line given in FIG. 6A.

FIG. 6B is a time-voltage diagram 650 showing a voltage level used to process first, second, and third portions 510-b, 515-b, and 520-b of a subframe 505-b. In some embodiments, the first, second, and third portions 510-b, 515-b, and 520-b may be examples of the first, second, and third portions 510, 515, and 520 of the subframe 505 described with reference to FIG. 5.

The first portion 510-b of the subframe 505-b may include control signaling; the second portion 515-b may include resources allocated to a same or another UE 115; and the third portion 520-b may include an allocation of physical resources identified, for example, in an uplink grant or a downlink grant.

A UE 115 may process data that is both within the first portion 510-b of the subframe 505-b and within a region 665 using a clock or other resource having a voltage level V1. The clock may have a first frequency. The voltage level V1 may in some cases be used in a wideband mode of operation, and may be a maximum voltage level used to process data received or transmitted by the UE 115.

Within a region 670, the UE 115 may transition from the voltage level V1 to a voltage level V2. The voltage level V2 may be used to conserve power when data is not being received in a region 675 (or when data of marginal bandwidth is being received). The voltage level V2 may in some cases be used in a narrowband mode of operation, and may be adjusted to a lower level than V1 based on the allocation of resources. Within a region 680, the UE 115 may transition from the voltage level V2 to a voltage level V3. The voltage level V3 may be adjusted to a higher level than V2 based on the allocation of resources to be utilized in the third portion 520-b of the subframe 505-b. The UE 115 may remain operating at voltage level V3 during portion 685 corresponding to the physical resources allocated to the UE 115 during the subframe 505-b Associated with V3 may be an adjusted clock frequency and/or bandwidth. The voltage level 655 of a processing voltage and/or clock may thus follow the trend line given in FIG. 6B.

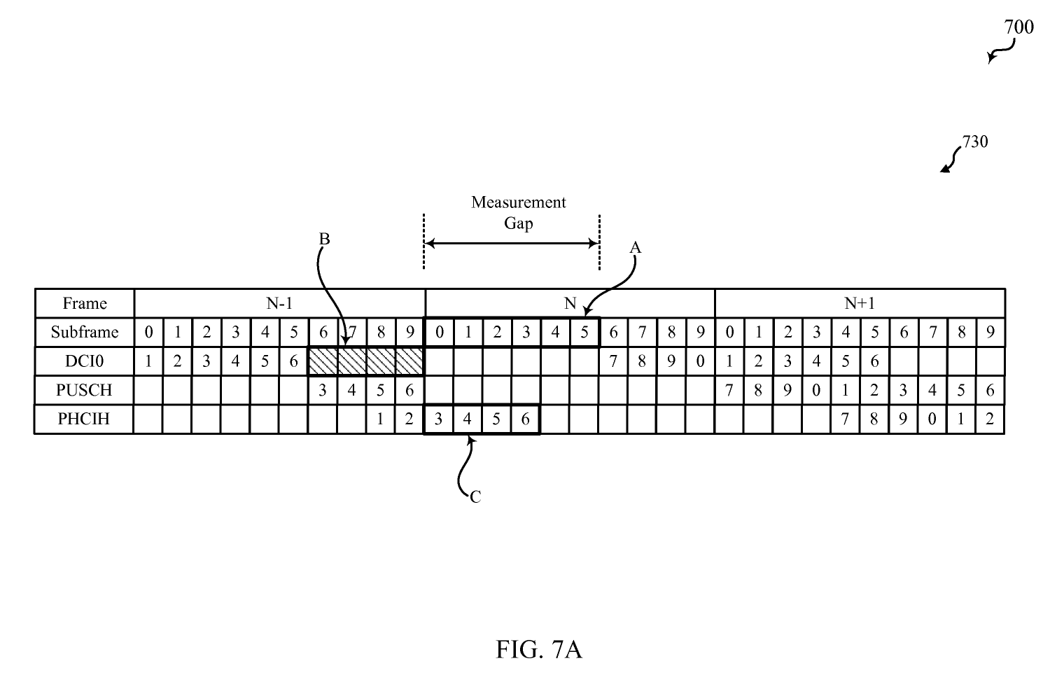

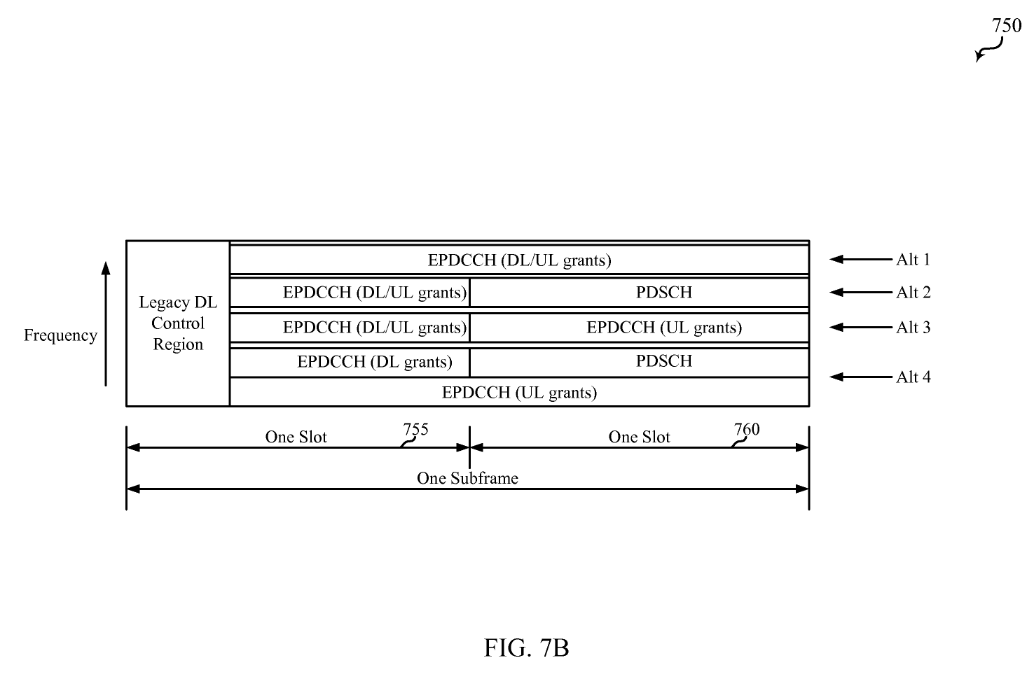

FIG. 7A shows a diagram 700 in which a frame sequence 730 illustrates various aspects of dynamic voltage and/or frequency adjusting during measurement gaps. As shown in the frame sequence 730, a gap (e.g., 6 ms) may arise every 40 ms or 80 ms, approximately, during a connected TX/RX mode. The gap in this example is shown in connection with a block A of six sub-frames in frame N. During this gap, the UE device (e.g., UE 115) may perform inter-frequency measurements and report signal parameters. As noted above, this kind of signal estimation may be performed using a 64-point FFT (where the physical layer broadcast channel, primary synchronization channel (P-SCH) and/or the secondary synchronization channel (S-SCH) reside). The P-SCH and S-SCH typically refer to the central 72-subcarriers. When adjusting (e.g., a scaled mode is applied) involves adjusting a clock, the adjusting may also involve voltage adjusting. Block B shown in FIG. 7A illustrates a block of four sub-frames in which DCIO may not be transmitted because a corresponding physical uplink shared channel (PUSCH) may fall within the measurement gap. Moreover, a block C of four sub-frames illustrates that a physical hybrid-ARQ indicator channel (PHICH) for PUSCH sub-frames 3, 4, 5, and 6 may not be transmitted because they may be within the measurement gap.

In another aspect related to using dynamic voltage and/or frequency adjusting in LTE, one or more of the adjusting schemes or techniques described herein may be applied to various features of OFDM/A or OFDMA. For example, when engaged in a TX/RX mode, a UE (e.g., UE 115), may perform a wide-band FFT using a 2048-point FFT. However, OFDM/A typically incorporates sub-20 MHz bandwidth blocks across the frequency access. Moreover, these blocks may change in each sub-frame. Generally, cellular chipsets used for OFDM/A applications tend to operate at the highest clock rate to perform wide-band analysis to report channel quality indication (CQI) wide-band and sub-bands. CQI reporting, however, may not be needed at all times and dynamic voltage and frequency adjusting may be applied.

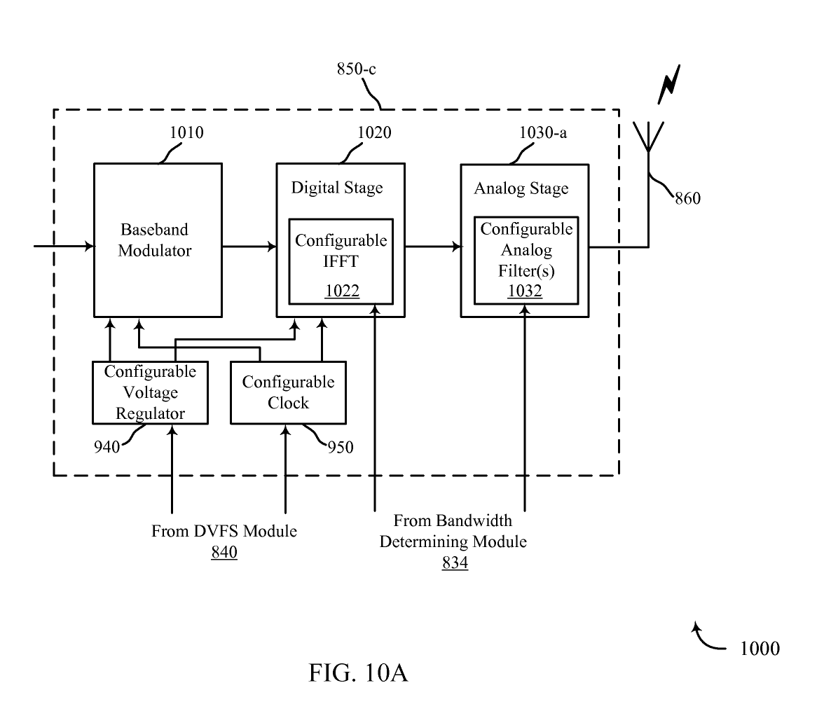

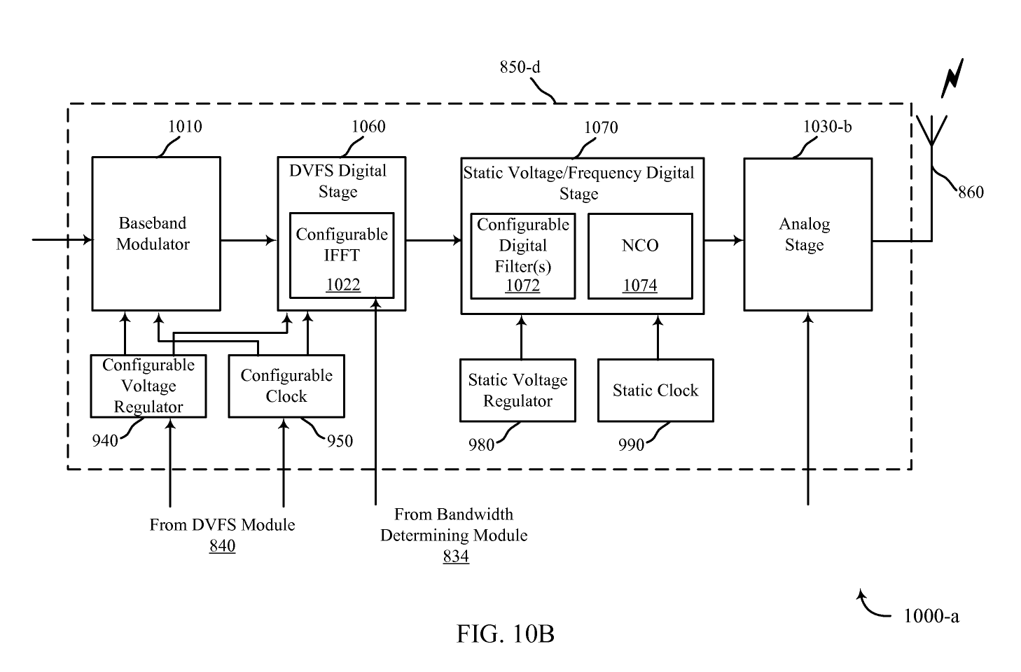

For example, a UE (e.g., UE 115) in LTE may not need to report wide-band CQI. The UE may then get assigned a resource block (e.g., physical resource block (PRB) of 0.5 ms and 12 sub-carriers) of about 5 MHz, for example, which is smaller than the 20 MHz total system bandwidth. The UE may detect this information in the first three or four OFDM symbols (see e.g., FIG. 10). In such a case, there may be no need to operate at the highest clock for a DL grant. Instead, it may be possible to adjust (e.g., scale) the clock and/or voltage to process the small bandwidth of data (e.g., 5 MHz), which is offset from the center frequency for the duration of the PRB. This approach may not be applicable to the first three or four OFDM symbols since those symbols are used to obtain the control data, which is wide-band.

The examples described above may allow for having the UE sleep in the frequency domain based on the characteristics of OFDM/A. Then, clock and/or voltage adjusting may be performed at line-rate and based on the PRB assignment. The above scheme may be abandoned for sub-frames where the UE is required to report a wideband CQI report to the eNodeB. Furthermore, in the event of a distributed PRB assignment, the clock selected may be commensurate with the highest bandwidth from the multiple bandwidths associated with each distributed PRB.

Next is provided information about LTE across its operational bandwidth in connection with implementing dynamic voltage and/or frequency adjusting. For at least some of the modes (e.g., channel bandwidths), for the 76 central subcarriers, a 128-point FFT may be used. However, to optimize the cell search process, the primary synchronization sequence (PSS) and the secondary synchronization sequence (SSS) may be transmitted in 64 subcarriers (e.g., PBCH) to allow for a 64-point FFT to be used. It may be possible, then, to operate at an adjusted clock of 1.92 MHz or lower as the dynamic range of the clock is quite high. This approach may provide great flexibility in adjusting the voltage for cell search measurement gaps (see e.g., FIG. 7A). A more general approach may be to perform a reduced, N-point FFT, select a minimum sample clock that is needed to perform the FFT (e.g., subcarrier frequency spacing×N) as granted by the PRB bandwidth, and adjust the voltage at line-rate processing of LTE DL/UL traffic. This more general approach may correspond to the implementation of a sleep function in the frequency domain.

In LTE Rel-11, for example, a new control channel (e.g., enhanced PDCCH (ePDCCH)) is introduced. Unlike the legacy PDCCH, which occupies the first several control symbols in a subframe, ePDCCH may occupy the data region, similar to PDSCH. ePDCCH may help increase control channel capacity, support frequency-domain inter-cell interference coordination (ICIC), achieve improved spatial reuse of control channel resources, support beamforming and/or diversity, operate on a new carrier type (NCT) and in multimedia broadcast single frequency network (MBSFN) subframes, and coexist on the same carrier as legacy UEs.

FIG. 7B illustrates an example subframe 750 with various options for ePDCCH, in accordance with various aspects of the present disclosure. The subframe is divided into a first slot 755 and a second slot 760, wherein each slot 755, 760 typically includes 7 symbols in LTE for the normal cyclic prefix (CP) case. Each subframe in LTE spans 1 ms, and therefore, each slot 755, 760 has a duration of 0.5 ms. The first 3 symbols of the subframe 750 may be used for the Physical Control Format Indicator Channel (PCFICH), the Physical HARQ Indicator Channel (PHICH), and PDCCH. Various ePDCCH structures are available for conveying information in the subframe, as illustrated. For certain aspects, ePDCCH may be frequency domain multiplexing (FDM)-based. Both localized and distributed transmission of the enhanced control channel may be supported. In aspects, the present methods for adaptive adjusting may be applied to enhanced PDCCH processing. For example, in aspects, if Alt 2 is used, ePDCCH will terminate in the first slot 755, and adaptive voltage and/or frequency adjusting for the second slot 760 can be triggered where virtual PRBs would be used to deliver unicast PDSCH data or no data at all. In aspects, if Alt 3 is used and the UE is not expecting any UL grant, the UE can decode the first slot 755 for possible DL grant and then trigger adaptive voltage and/or frequency adjusting. In aspects, if Alt 1 or Alt 4 is used, adaptive voltage and/or frequency adjusting may not be employed. In aspects, if distributed ePDCCH allocation is used, adaptive voltage and/or frequency adjusting may not be employed.

In aspects, the present methods for adaptive adjusting may be applied to Voice over LTE (VoLTE) processing. For example, DVFS may play a vital role in lowering power consumption in VoLTE applications. VoLTE typically uses small speech packets every ˜20 ms and may require much less bandwidth allocation than other applications. With semi-persistent scheduling of the time-axis, an eNodeB would grant smaller chunks of physical resource blocks to a UE. In a pure voice call, with SPS, the present methods and apparatus for adaptive adjusting may allow the modem to operate with a reduced voltage and/or clock by knowing the smaller PRB chunks.

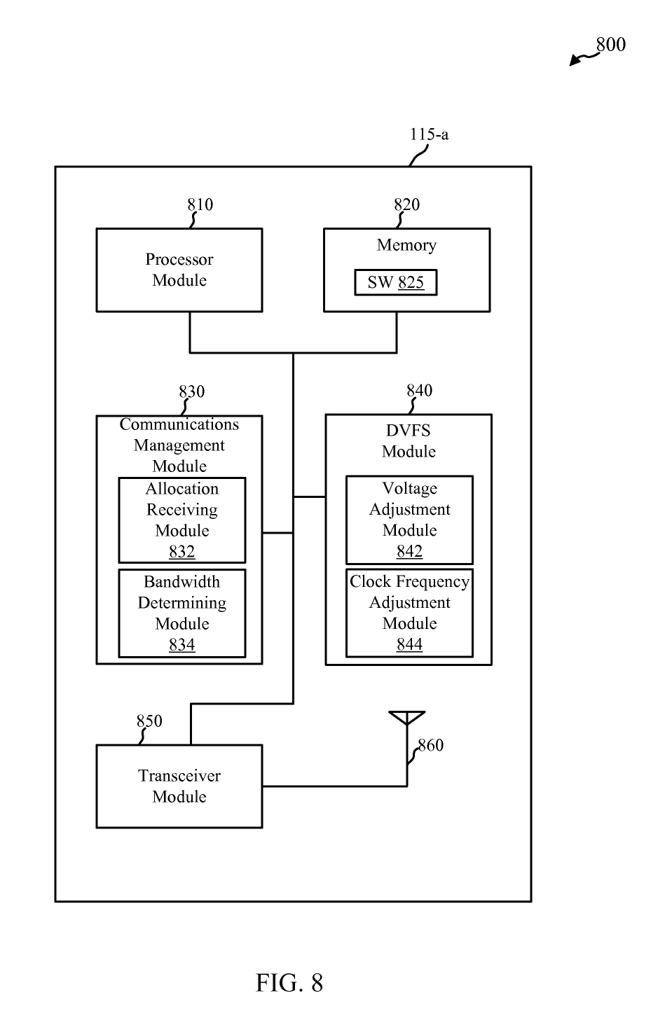

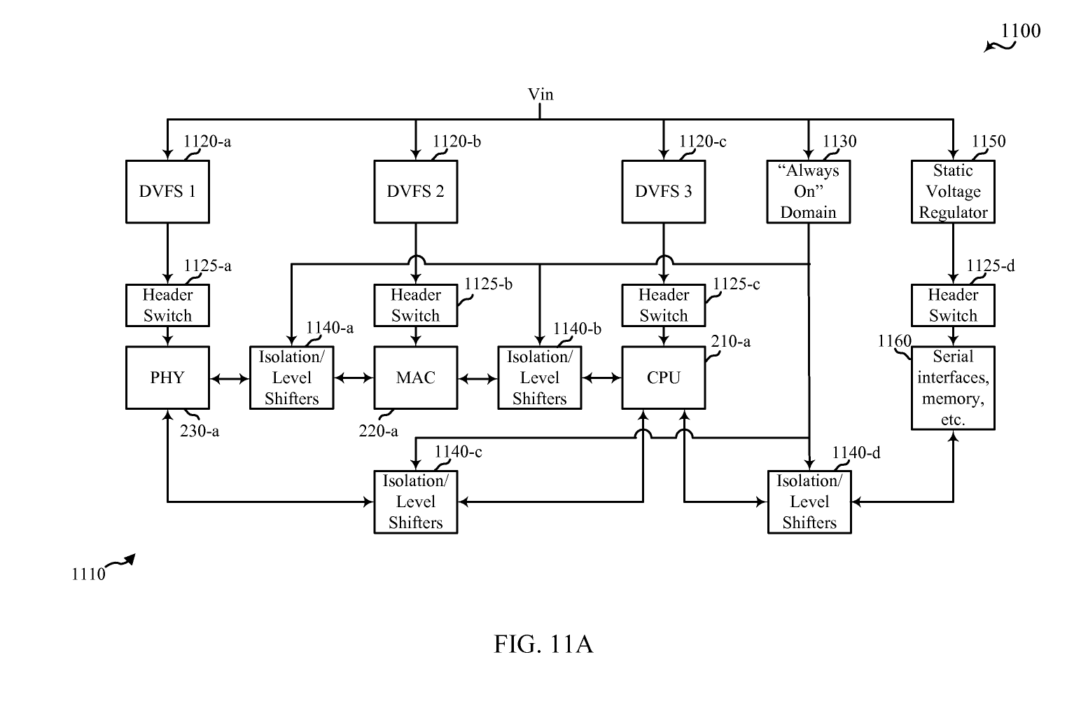

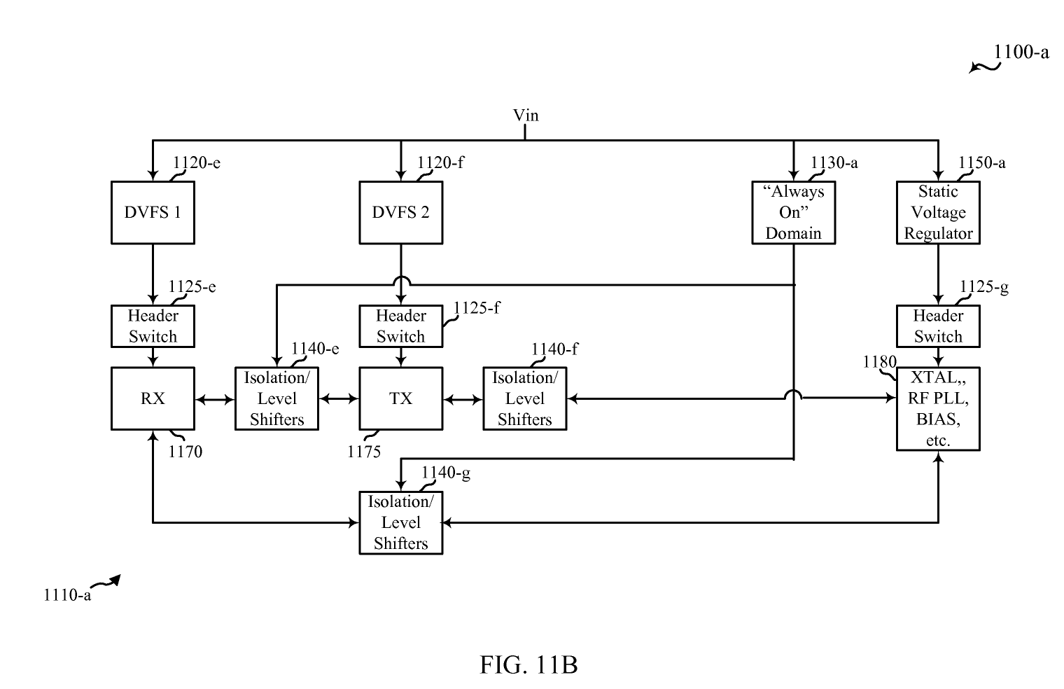

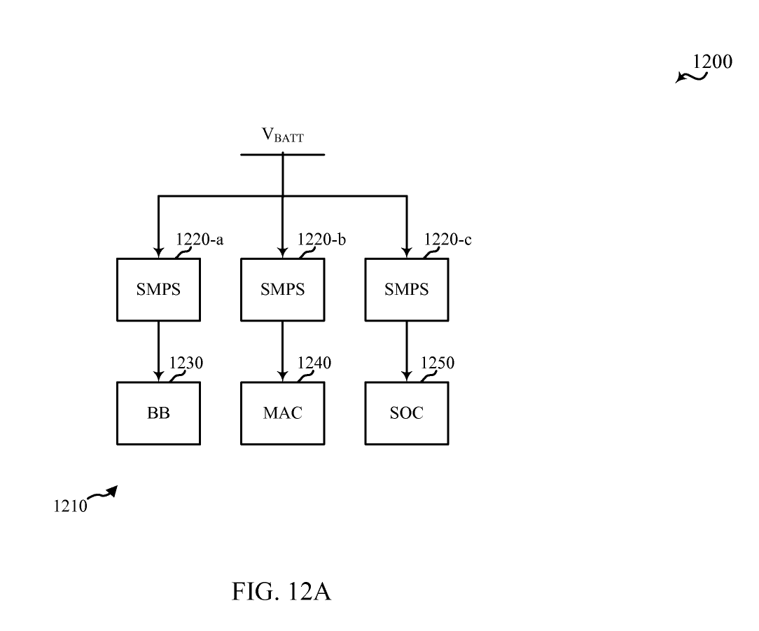

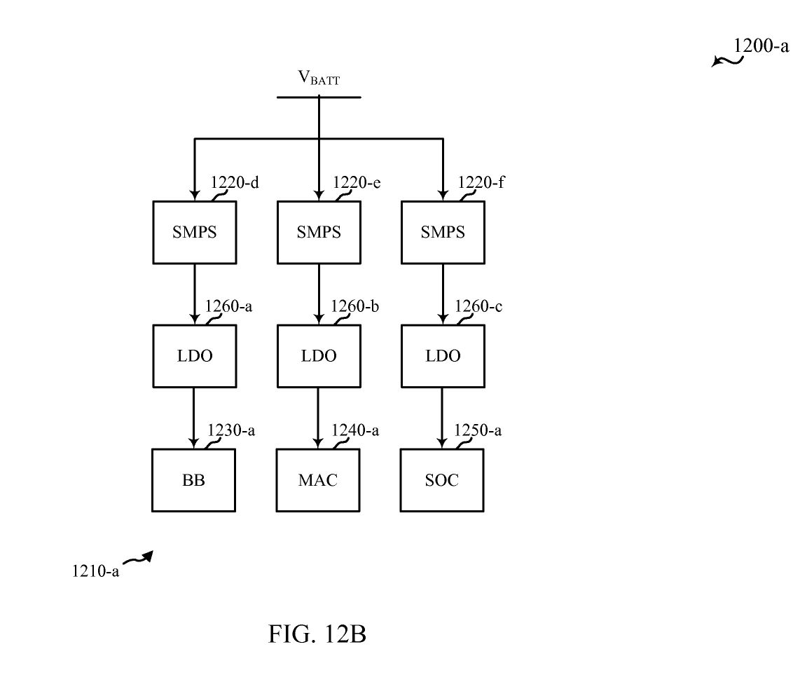

Turning next to FIG. 8, a diagram 800 is shown that illustrates an UE 115-a configured for dynamic voltage and/or frequency adjusting. The UE 115-a may be used with cellular networks (e.g., LTE) and connects through base stations, and/or in WLAN or Wi-Fi communications and connects through an access point, for example. The UE 115-a may have various other configurations and may be included or be part of a personal computer (e.g., laptop computer, netbook computer, tablet computer, etc.), a cellular telephone, a PDA, a digital video recorder (DVR), an internet appliance, a gaming console, an e-reader, etc. The UE 115-a may have an internal power supply (not shown), such as a small battery, to facilitate mobile operation. The UE 115-a may be an example of the user equipment 115 of FIG. 1. The UE 115-a may include the device 200 of FIG. 2, the device 1110 and/or 1110-a of FIG. 11A and/or FIG. 11B, and/or the device 1210 and/or 1210-a of FIG. 12A and FIG. 12B. The UE 115-a may be referred to as a wireless communications device, a user equipment, or a station in some cases.

The UE 115-a may include antennas 860, a transceiver module 850, a memory 820, and/or a processor module 810, which each may be in communication, directly or indirectly, with each other (e.g., via one or more buses). The transceiver module 850 may be configured to communicate bi-directionally, via the antennas 860 and/or one or more wired or wireless links, with one or more networks, as described above. For example, the transceiver module 850 may be configured to communicate bi-directionally with the base stations 105 of FIG. 1 and/or the access points 120 of FIG. 1. The transceiver module 850 may be implemented as a transmitter module and a separate receiver module. The transceiver module 850 may include a modem configured to modulate the packets and provide the modulated packets to the antennas 860 for transmission, and to demodulate packets received from the antennas 860. The modem may include at least a portion of the device 200 described with respect to FIG. 2. While the UE 115-a may include a single antenna, there may be embodiments in which the UE 115-a may include multiple antennas 860.

The memory 820 may include random access memory (RAM) and read-only memory (ROM). The memory 820 may store computer-readable, computer-executable software code 825 containing instructions that are configured to, when executed, cause the processor module 810 to perform or control various functions described herein for dynamic voltage and frequency adjusting. Alternatively, the computer-executable software code 825 may not be directly executable by the processor module 810 but be configured to cause the computer (e.g., when compiled and executed) to perform functions described herein.

The processor module 810 may include an intelligent hardware device, e.g., a central processing unit (CPU) such as those made by Intel® Corporation or AMD®, a microcontroller, an ASIC, etc. The processor module 810 may process information received through the transceiver module 850 and/or to be sent to the transceiver module 850 for transmission through the antennas 860. The processor module 810 may handle, alone or in connection with the DVFS module 840, various aspects of dynamic voltage and frequency adjusting.

According to the architecture of FIG. 8, the UE 115-a may further include a communications management module 830. The communications management module 830 may manage communications with other user equipments 115, with various base stations (e.g., macro cells, small cells), and/or with various access points 120. By way of example, the communications management module 830 may be a component of the UE 115-a in communication with some or all of the other components of the UE 115-a via a bus (as shown in FIG. 8). Alternatively, functionality of the communications management module 830 may be implemented as a component of the transceiver module 850, as a computer program product, and/or as one or more controller elements of the processor module 810. The communications management module 830 may include an allocation receiving module 832 and/or a bandwidth determining module 834. The allocation receiving module 832 may be configured to perform one or more aspects of receiving an allocation of physical resources (e.g., PRBs), which allocation of physical resources may be utilized by the UE 115-a during one or more portions of a subframe. The bandwidth determining module 834 may be configured to perform one or more aspects of determining, based on the allocation of physical resources received by the allocation receiving module 832, one or more bandwidths to be utilized during the one or more portions of the subframe. The one or more bandwidths may in some cases be determined from multiple bandwidths supported by the UE 115-a.

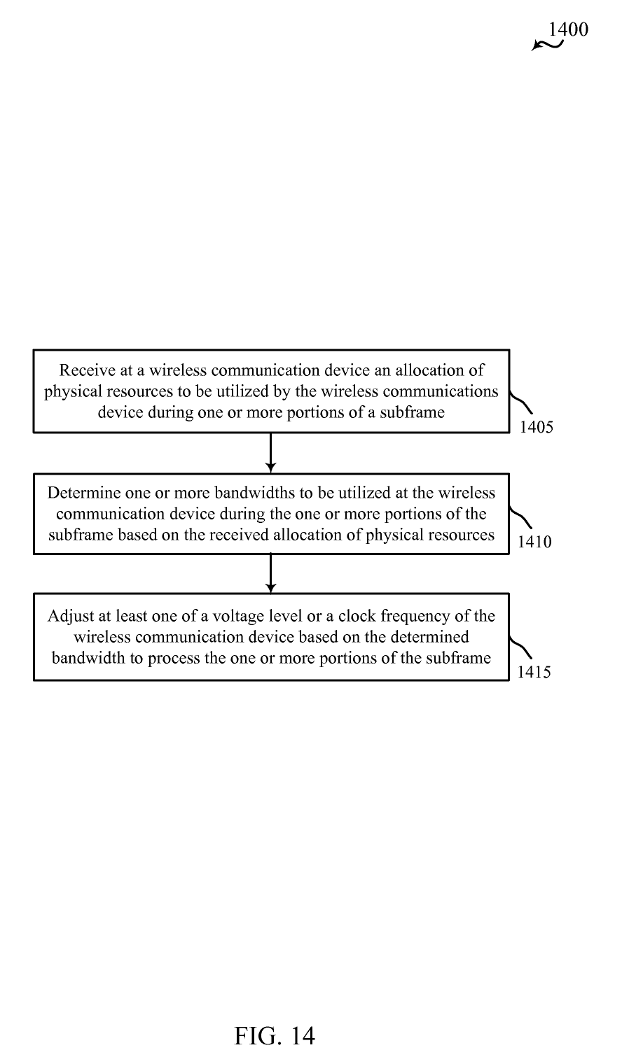

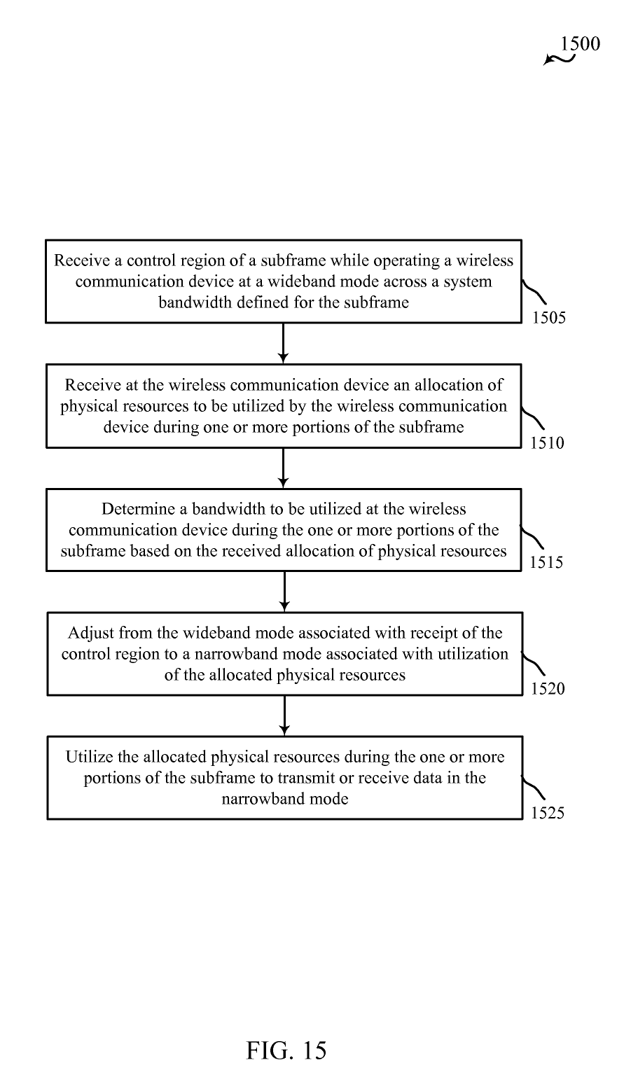

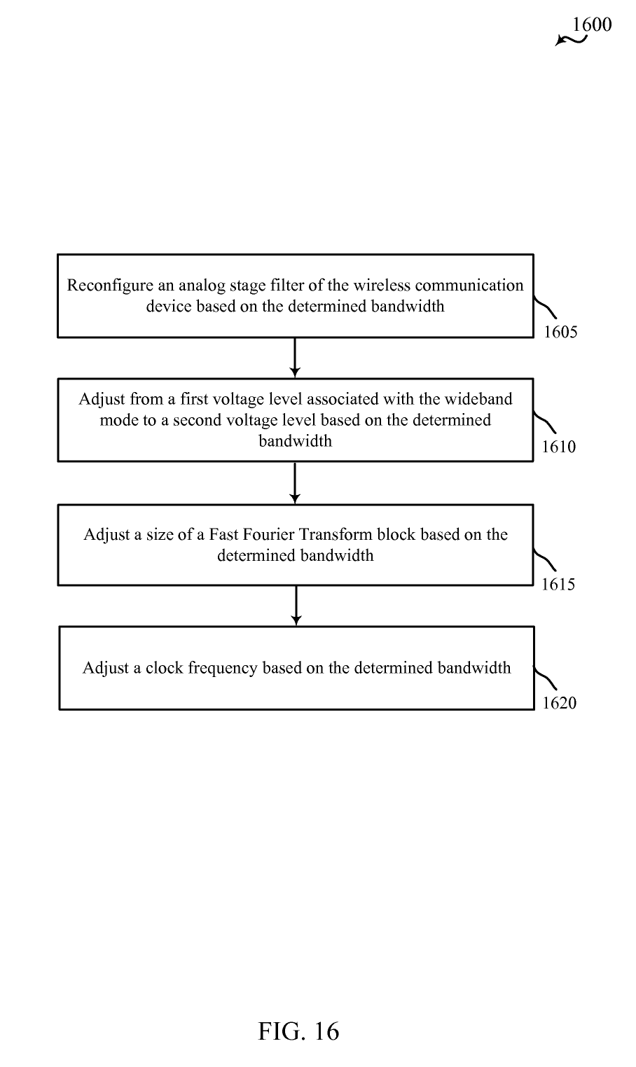

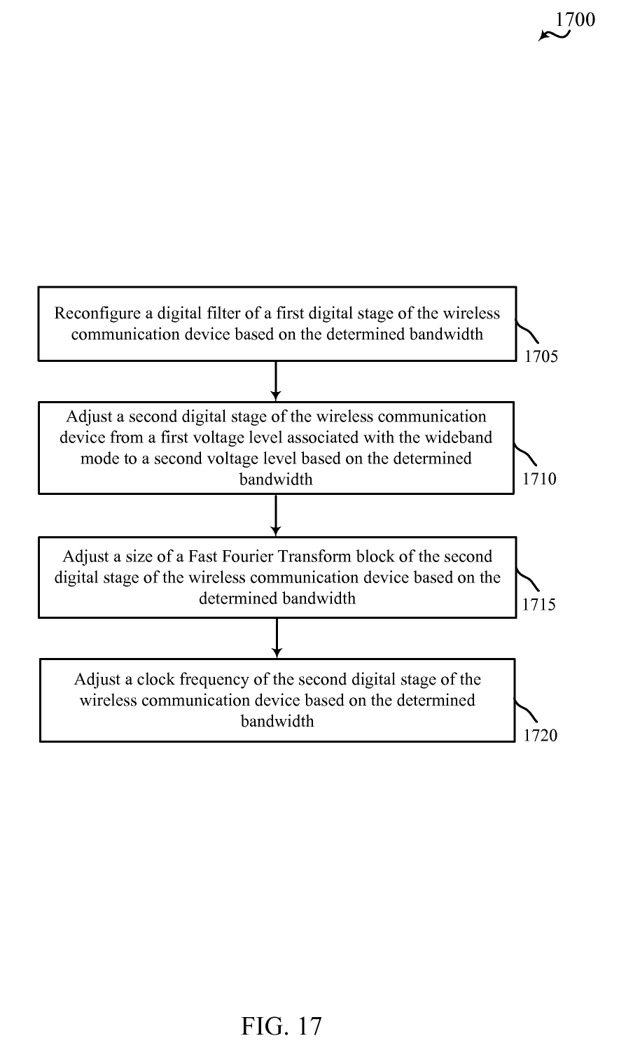

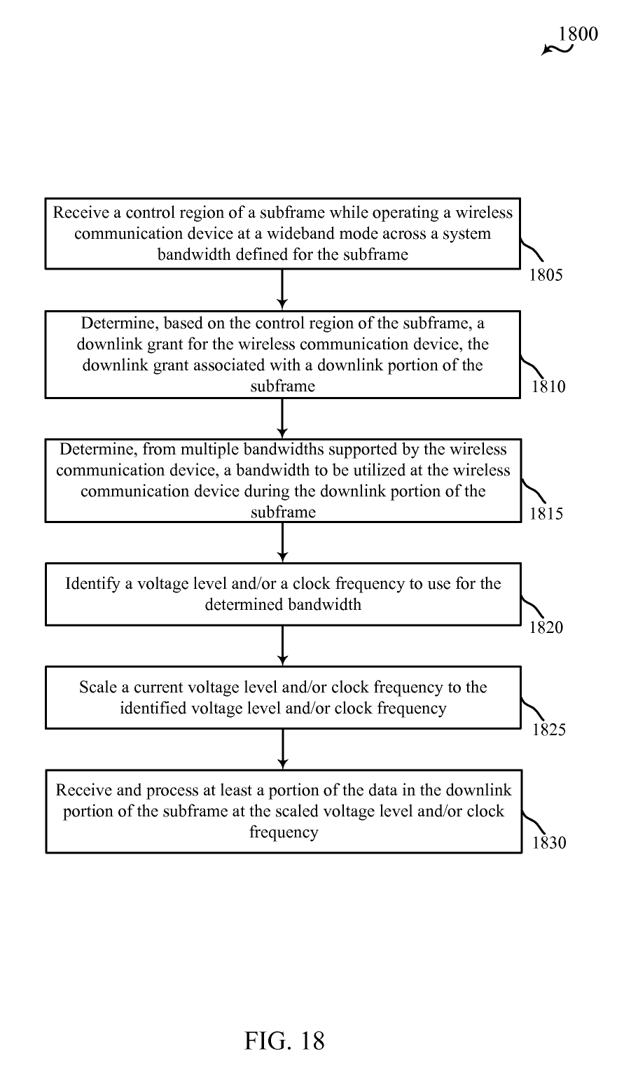

The components of the UE 115-a may be configured to implement aspects discussed above with respect to device 200, and discussed below with respect to device 1110, 1110-a, 1210, and 1210-a and those aspects may not be repeated here for the sake of brevity. The components of the UE 115-a may be configured to implement aspects discussed above with respect to the diagrams in FIG. 3, FIG. 4, FIG. 5, FIG. 6A, FIG. 6B, FIG. 7A, and/or FIG. 7B. Moreover, the components of the UE 115-a may be configured to implement aspects discussed below with respect to the method 1400, 1500, 1600, 1700, and/or 1800 of FIG. 14, FIG. 15, FIG. 16. FIG. 17, and/or FIG. 18, respectively, and those aspects may not be repeated here also for the sake of brevity.

The UE 115-a may also include the DVFS module 840, which as described above, may be configured to handle various aspects of dynamic voltage and frequency adjusting. The DVFS module 840 may include a voltage adjustment module 842 and/or a clock frequency adjustment module 844. The voltage adjustment module 842 may be configured to perform one or more aspects of adjusting (e.g., scaling) a voltage level of the UE 115-a based on one or more bandwidths that the bandwidth determining module 834 determines the UE 115-a should utilize when processing one or more portions of a subframe for which an allocation of physical resources has been received by the UE 115-a. The clock frequency adjustment module 844 may be configured to perform one or more aspects of adjusting an analog clock frequency and/or a digital clock frequency of the UE 115-a based on one or more bandwidths that the bandwidth determining module 834 determines the UE 115-a should utilize when processing one or more portions of a subframe for which an allocation of physical resources has been received by the UE 115-a.

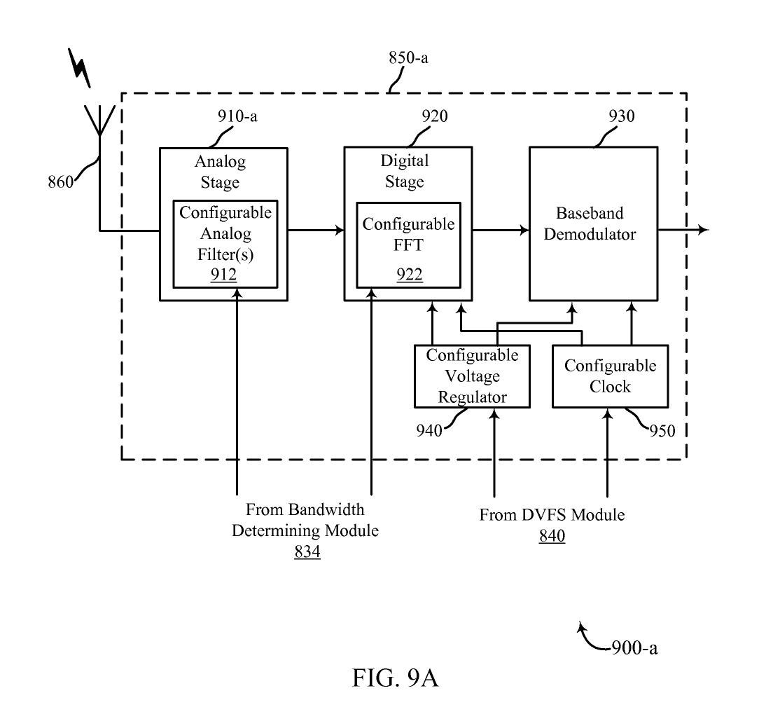

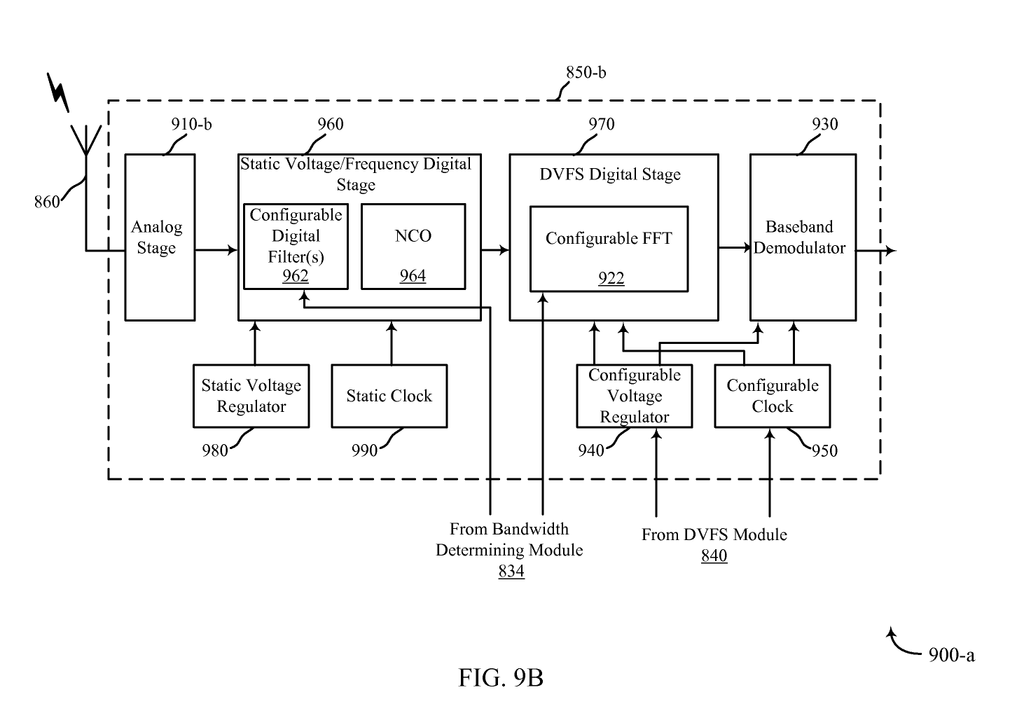

FIG. 9A shows a diagram 900 that illustrates a transceiver module 850-a, which transceiver module 850-a may be an example of the transceiver module 850 of FIG. 8. The transceiver module 850-a may receive data via antennas 860 and may include an analog stage 910-a, a digital stage 920, a baseband demodulator 930, a configurable voltage regulator 940, and/or a configurable clock module 950. The transceiver module 850-a, or at least portions of it, may include a processor.

The analog stage 910-a may include one or more configurable analog filter(s) 912 (e.g., one or more analog front-end filter). Each of the configurable analog filter(s) 912 may have a filter bandwidth covering a range of frequency subcarriers over which data may be received by the transceiver module 850-a, and may have a center frequency and bandwidth that are changeable based on an allocation of physical resources that is to be utilized for receiving data during one or more portions of a subframe. In some cases, the center frequency and bandwidth of each of the configurable analog filter(s) 912 may be configured (or reconfigured) based on a programming signal or signals received from the bandwidth determining module 834 of the UE 115-a described with reference to FIG. 8. An analog domain clock used by the analog stage 910-a may also be adjusted based on the programming signal or signals received from the bandwidth determining module 834.

In some embodiments, the configurable analog filter(s) 912 may have as many center frequency and bandwidth modes as there are physical resources (e.g., PRBs). In other embodiments, the configurable analog filter(s) 912 may have fewer center frequency and bandwidth modes.

In some embodiments, the time required to change the bandwidth and center frequency of each of the configurable analog filter(s) 912 may be constrained to a few (e.g., two or three) OFDM symbols.

In some embodiments, and by way of example, the configurable analog filter(s) 912 may be reconfigured from a wideband mode (e.g., a DC centered operation in a PDCCH stage) to a narrowband mode centered on arbitrary physical resource locations within one or more portions of a subframe.

The digital stage 920 may receive data from the analog stage 910-a and may include a configurable Fast Fourier Transform (FFT) module 922. A size of an FFT transform may be adjusted based on the programming signal or signals received from the bandwidth determining module 834. In addition to the configurable FFT module 922, the digital stage 920 may have a digital filter and/or other components that are operable at an adjustable voltage level and/or clock frequency. An adjusted voltage level may be provided by the configurable voltage regulator 940, and a digital domain clock having an adjusted clock frequency may be provided by the configurable clock module 950. Each of the configurable voltage regulator 940 and the configurable clock module 950 may be configured (or reconfigured) based on a programming signal or signals received from the DVFS module 840 of the UE 115-a described with reference to FIG. 8. In particular, the configurable voltage regulator 940 may receive a programming signal or signals provided by the voltage adjustment module 842, and the configurable clock module 950 may receive a programming signal or signals provided by the clock frequency adjustment module 844.

The baseband demodulator 930 may receive data from the digital stage 920 and may also have components that are operable at an adjustable voltage level and/or clock frequency. As with the digital stage 920, the baseband demodulator 930 may receive an adjusted voltage level from the configurable voltage regulator 940 and/or a digital domain clock (e.g., a sampling clock) having an adjusted clock frequency from the configurable clock module 950. The baseband demodulator 930 may provide data to a downstream stage of a UE 115 for further processing.

When the configurable analog filters(s) 912 are configured to operate over a smaller bandwidth, the digital stage 920 and baseband demodulator 930 may perform their processing using a reduced sampling clock and/or a smaller FFT size.

FIG. 9B shows a diagram 900-a that illustrates a transceiver module 850-b, which transceiver module 850-b may be an example of the transceiver module 850 of FIG. 8. The transceiver module 850-b may receive data via antennas 860 and may include an analog stage 910-b, a static voltage/frequency digital stage 960, a DVFS digital stage 970, a baseband demodulator 930, a static voltage regulator 980, a static clock module 990, a configurable voltage regulator 940, and/or a configurable clock module 950. The transceiver module 850-b, or at least portions of it, may include a processor.

The analog stage 910-a may include, for example, one or more wideband analog filter(s) having DC centered frequencies. The use of one or more wideband analog filter(s) may in some cases reduce the complexity of the transceiver module 850-b over the transceiver module 850-a described with reference to FIG. 9A.

The static voltage/frequency digital stage 960 may receive data from the analog stage 910-b and may include components that are operable at a static voltage level or clock frequency. A static voltage level may be provided by the static voltage regulator 980, and a digital domain clock having a static clock frequency may be provided by the static clock module 990. The static voltage/frequency digital stage 960 may include one or more configurable digital filter(s) 962. Each of the configurable digital filter(s) 962 may utilize digital domain filtering and down-mixing (e.g., using a numerically controlled oscillator (NCO 964)) to zoom to a bandwidth of an allocation of physical resources that is to be utilized for receiving data during one or more portions of a subframe. In some cases, the configurable digital filter(s) 962 may be configured (or reconfigured) based on a programming signal or signals received from the bandwidth determining module 834 of the UE 115-a described with reference to FIG. 8.

In some embodiments, the configurable digital filter(s) 962 may have as many bandwidth modes as there are physical resources (e.g., PRBs). In other embodiments, the configurable digital filter(s) 962 may have fewer bandwidth modes.

In some embodiments, and by way of example, the configurable digital filter(s) 962 may be reconfigured from a wideband mode (e.g., an operation in a PDCCH stage) to a narrowband mode centered on arbitrary physical resource locations within one or more portions of a subframe.

The DVFS digital stage 970 may receive data from the static voltage/frequency digital stage 960 and may include a configurable Fast Fourier Transform (FFT) module 922. A size of an FFT transform may be adjusted based on the programming signal or signals received from the bandwidth determining module 834. In addition to the configurable FFT module 922, the DVFS digital stage 970 may have a digital filter and/or other components that are operable at an adjustable voltage level and/or clock frequency. An adjusted voltage level may be provided by the configurable voltage regulator 940, and a digital domain clock having an adjusted clock frequency may be provided by the configurable clock module 950. Each of the configurable voltage regulator 940 and the configurable clock module 950 may be configured (or reconfigured) based on a programming signal or signals received from the DVFS module 840 of the UE 115-a described with reference to FIG. 8. In particular, the configurable voltage regulator 940 may receive a programming signal or signals provided by the voltage adjustment module 842, and the configurable clock module 950 may receive a programming signal or signals provided by the clock frequency adjustment module 844.

The baseband demodulator 930 may receive data from the DVFS digital stage 970 and may also have components that are operable at an adjustable voltage level and/or clock frequency. As with the DVFS digital stage 970, the baseband demodulator 930 may receive an adjusted voltage level from the configurable voltage regulator 940 and/or a digital domain clock (e.g., a sampling clock) having an adjusted clock frequency from the configurable clock module 950. The baseband demodulator 930 may provide data to a downstream stage of a UE 115 for further processing.

When the configurable digital filters(s) 962 are configured to operate over a smaller bandwidth, the DVFS digital stage 970 and baseband demodulator 930 may perform their processing using a reduced sampling clock and/or a smaller FFT size.

FIG. 10A shows a diagram 1000 that illustrates a transceiver module 850-c, which transceiver module 850-c may be an example of the transceiver module 850 and/or 850-a of FIG. 8 and/or FIG. 9A. The transceiver module 850-c may transmit data via antennas 860 and may include a baseband modulator 1010, a digital stage 1020, an analog stage 1030, a configurable voltage regulator 940, and/or a configurable clock module 950. The transceiver module 850-c, or at least portions of it, may include a processor.

The baseband modulator 1010 may receive data from an upstream stage of a UE 115 and may have components that are operable at an adjustable voltage level and/or clock frequency. An adjusted voltage level may be provided by the configurable voltage regulator 940, and a digital domain clock having an adjusted clock frequency may be provided by the configurable clock module 950. Each of the configurable voltage regulator 940 and the configurable clock module 950 may be configured (or reconfigured) based on a programming signal or signals received from the DVFS module 840 of the UE 115-a described with reference to FIG. 8. In particular, the configurable voltage regulator 940 may receive a programming signal or signals provided by the voltage adjustment module 842, and the configurable clock module 950 may receive a programming signal or signals provided by the clock frequency adjustment module 844.

The digital stage 1020 may receive data from the baseband modulator 1010 and may include a configurable inverse Fast Fourier Transform (IFFT) module 1022. A size of an IFFT transform may be adjusted based on the programming signal or signals received from the bandwidth determining module 834 of the UE 115-a described with reference to FIG. 8. In addition to the configurable IFFT module 1022, the digital stage 1020 may have a digital filter and/or other components that are operable at an adjustable voltage level and/or clock frequency. As with the baseband modulator 1010, the digital stage 1020 may receive an adjusted voltage level from the configurable voltage regulator 940 and/or a digital domain clock (e.g., a sampling clock) having an adjusted clock frequency from the configurable clock module 950.

The analog stage 1030-a may receive data from the digital stage 1020 and may include one or more configurable analog filter(s) 1032 (e.g., one or more analog back-end filter) and provide data to the antennas 860. Each of the configurable analog filter(s) 1032 may have a filter bandwidth covering a range of frequency subcarriers over which data may be transmitted by the transceiver module 850-c, and may have a center frequency and bandwidth that are changeable based on an allocation of physical resources that is to be utilized for transmitting data during one or more portions of a subframe. In some cases, the center frequency and bandwidth of each of the configurable analog filter(s) may be configured (or reconfigured) based on a programming signal or signals received from the bandwidth determining module 834. An analog domain clock used by the analog stage 1030-a may also be adjusted based on the programming signal or signals received from the bandwidth determining module 834.

In some embodiments, the configurable analog filter(s) 1032 may have as many center frequency and bandwidth modes as there are physical resources (e.g., PRBs). In other embodiments, the configurable analog filter(s) 1032 may have fewer center frequency and bandwidth modes.

In some embodiments, the time required to change the bandwidth and center frequency of each of the configurable analog filter(s) 1032 may be constrained to a few (e.g., two or three) OFDM symbols.

FIG. 10B shows a diagram 1000-a that illustrates a transceiver module 850-d, which transceiver module 850-d may be an example of the transceiver module 850 and/or 850-b of FIG. 8 and/or FIG. 9B. The transceiver module 850-d may transmit data via antennas 860 and may include a baseband modulator 1010, a DVFS digital stage 1060, a static voltage/frequency digital stage 1070, an analog stage 1030-b, a configurable voltage regulator 940, a configurable clock module 950, a static voltage regulator 980, and/or a static clock module 990. The transceiver module 850-d, or at least portions of it, may include a processor.

The baseband modulator 1010 may receive data from an upstream stage of a UE 115 and may have components that are operable at an adjustable voltage level and/or clock frequency. An adjusted voltage level may be provided by the configurable voltage regulator 940, and a digital domain clock having an adjusted clock frequency may be provided by the configurable clock module 950. Each of the configurable voltage regulator 940 and the configurable clock module 950 may be configured (or reconfigured) based on a programming signal or signals received from the DVFS module 840 of the UE 115-a described with reference to FIG. 8. In particular, the configurable voltage regulator 940 may receive a programming signal or signals provided by the voltage adjustment module 842, and the configurable clock module 950 may receive a programming signal or signals provided by the clock frequency adjustment module 844.

The DVFS digital stage 1060 may receive data from the baseband modulator 1010 and may include a configurable inverse Fast Fourier Transform (IFFT) module 1022. A size of an IFFT transform may be adjusted based on the programming signal or signals received from the bandwidth determining module 834 of the UE 115-a described with reference to FIG. 8. In addition to the configurable IFFT module 1022, the DVFS digital stage 1060 may have a digital filter and/or other components that are operable at an adjustable voltage level and/or clock frequency. As with the baseband modulator 1010, the DVFS digital stage 1060 may receive an adjusted voltage level from the configurable voltage regulator 940 and/or a digital domain clock (e.g., a sampling clock) having an adjusted clock frequency from the configurable clock module 950.

The static voltage/frequency digital stage 1070 may receive data from the DVFS digital stage 1060 and may include components that are operable at a static voltage level and/or clock frequency. A static voltage level may be provided by the static voltage regulator 980, and a digital domain clock having a static clock frequency may be provided by the static clock module 990. The static voltage/frequency digital stage 1070 may include one or more configurable digital filter(s) 1072. Each of the configurable digital filter(s) 1072 may utilize digital domain filtering and down-mixing (e.g., using an NCO 1074) to zoom to a bandwidth of an allocation of physical resources that is to be utilized for receiving data during one or more portions of a subframe. In some cases, the configurable digital filter(s) 1072 may be configured (or reconfigured) based on a programming signal or signals received from the bandwidth determining module 834 of the UE 115-a described with reference to FIG. 8.

In some embodiments, the configurable digital filter(s) 1072 may have as many bandwidth modes as there are physical resources (e.g., PRBs). In other embodiments, the configurable digital filter(s) 1072 may have fewer bandwidth modes.

The analog stage 1030-b may receive data from the static voltage/frequency digital stage 1070 and may include, for example, one or more wideband analog filter(s) having DC centered frequencies. The use of one or more wideband analog filter(s) may in some cases reduce the complexity of the transceiver module 850-d over the transceiver module 850-c described with reference to FIG. 10A.

FIG. 11A shows a diagram 1100 that illustrates an example of a device 1110 where each of the components is included in an independent voltage domain. According to the architecture of FIG. 11A, a PHY 230-a with a header switch 1125-a and a DVFS 1 1120-a, a MAC 220-a with a header switch 1125-b and a DVFS 2 1120-b, and a CPU 210-a with a header switch 1125-c and a DVFS 3 1120-c, are each in a different DVFS (e.g., in-subframe DVFS) domain. These domains are separated by isolation/level shifters 1140-a, 1140-b, and 1140-c. The PHY 230-a, the MAC 220-a, and the CPU 210-a may be examples of the PHY 230, the MAC 220, and the CPU 210 of FIG. 2, respectively.

In addition to the DVFS domains supported by the DVFS 1 1120-a, the DVFS 2 1120-b, and the DVFS 3 1120-c, an “Always On Domain” module 1130 may provide appropriate voltage and/or frequency for the continuous operation of the isolation/level shifters 1140-a, 1140-b, 1140-c, and 1140-d. Moreover, the serial interfaces and memory 1160 with a header switch 1125-d and a static voltage regulator 1150 may be part of a separate, static, and non-DVFS domain, separated from the DVFS 3 domain 1120-c by the isolation/level shifter 1140-d. Note that the three DVFS domains, the “Always On” domain, and the static domain are provided with the same voltage level, Vin, which may originate from a common source.

The DVFS 1 1120-a, DVFS 2 1120-b, and DVFS 3 1120-c create unique supply rails per digital block and can each be a switching regulator or an LDO. The static voltage regulator 1150 creates a unique supply rail that is a fixed voltage and can be a switching regulator or an LDO.

FIG. 11B shows a diagram 1100-a that illustrates an example of a device 1110-a where each of the components is included in an independent domain. According to the architecture of FIG. 11B, a receiver (RX) 1170 with a header switch 1125-a and a DVFS 1 1120-a, and a transmitter (TX) 1175 with a header switch 1125-e and a DVFS 2 1120-f, are each in a different DVFS domain. These domains are separated by an isolation/level shifter 1140-e. The RX 1170 and the TX 1175 may be examples of an RF receiver and an RF transmitter, respectively, which may be included in the transceiver module 250 of FIG. 2.

In addition to the DVFS domains supported by the DVFS 1 1120-e and DVFS 2 1120-f, an “Always On Domain” module 1130-a may provide appropriate voltage and/or frequency for the continuous operation of the isolation/level shifters 1140-e, 1140-f, and 1140-g. Moreover, the crystal (XTAL)/RF phase-locked loop (PLL)/BIAS 1180 with a header switch 1125-g and a static voltage regulator 1150-a may be part of a separate, static, and non-DVFS domain, separated from the DVFS domains by the isolation/level shifters 1140-f and 1140-g. Note that the two RF DVFS domains, the “Always On” domain, and the static domain are provided with the same voltage level, Vin, which may originate from a common source.

The DVFS 1 1120-e and the DVFS 2 1120-f create unique supply rails per digital block and can each be a switching regulator or an LDO. The static voltage regulator 1150-a creates a unique supply rail that is a fixed voltage and can be a switching regulator or an LDO. In some instances, there may be multiple static voltage regulators 1150-a per analog block that require a fixed supply independent of the PHY rate.

The use of dynamic voltage and/or frequency adjusting for RF and/or analog modules as shown in FIG. 11B may also be implemented in accordance to different modes of operation. For example, in a static mode, the voltage to the RF/Analog modules from a low noise amplifier (LNA) to an analog-to-digital converter (ADC) may be scaled, tying the RF scaling to the digital dynamic voltage and frequency adjusting. In some cases, adjusting the voltage may increase the analog receive gain (RxGain). Compensation circuits may be used in the RX path to mitigate any possible increases of RxGain. The compensation circuits may be implemented after the RxGain effects have been characterized. Another approach that may mitigate or minimize the effect of scaling in RF/analog modules may be to scale the baseband blocks independently from the RF blocks.

In a dynamic mode, RF analog filters may be switched from a lower bandwidth to a higher bandwidth in a timeline that corresponds to that of dynamic voltage and/or frequency adjusting (e.g., duration of <10 μs). However, implementing fast analog filter switching may present some challenges. Other aspects may include having RF PLL, BIAS, and XTAL in a static voltage domain as shown in FIG. 11B. Moreover, the transmit (TX) and receive (RX) blocks of the RF portion of a wireless modem may be on independent DVFS voltage domains as shown in FIG. 11B.

FIG. 12A is a diagram 1200 that illustrates a device 1210 in which the voltages for a digital baseband (BB) processor 1230, a media access controller (MAC) 1240, and a System-on-Chip (SOC) 1250 are adjusted independently by different SMPS 1220-a through 1220-c. The BB 1230 may be an example of the baseband module 240 of FIG. 2. The MAC 1240 may be an example of the MAC modules 220 and 220-a of FIG. 2 and FIG. 11A, respectively. The SOC 1250 may be an example of the CPU modules 210 and 210-a of FIG. 2 and FIG. 11A, respectively.

The following expressions describe the power analysis associated with the dynamic voltage adjusting using SMPSs 1220 e.g., direct scaling):

V_{SCALED}=V_{SMPS}

I_{LOAD}=C×V_{SMPS}×F

I_{BATT}=I_{LOAD}×(V_{SMPS}/V_{BATT})×(1/e)

P=V_{BATT}×I_{BATT}

where V_{SCALED}=output of the SMPS, e=efficiency of SMPS, I_{BATT}=current drawn at battery, V_{BATT}=battery voltage, I_{LOAD}=current drawn at each block; C=load capacitance, F=block operational frequency, and P=power. The power calculations may be as follows:

Power before scaling: (C×F)×(V_{SMPS})²×(1/e)

Power after scaling: (C×F)×(V_{SCALED})²×(1/e)

which results in power savings that may be proportional to V² at V_{BATT}.

Turning to FIG. 12B, a diagram 1200-a is shown that illustrates a device 1210-a in which the voltages for a BB 1230-a, a MAC 1240-a, and an SOC 1250-a are being adjusted indirectly and independently by different SMPS 1220-d through 1220-f and respective LDOs 1260-a through 1260-c. The BB 1230-a may be an example of the baseband module 240 of FIG. 2 and the BB 1230 of FIG. 12A. The MAC 1240-a may be an example of the MAC modules 220 and 220-a of FIG. 2 and FIG. 11A, respectively, and of the MAC 1240 of FIG. 12A. The SOC 1250-a may be an example of the CPU modules 210 and 210-a of FIG. 2 and FIG. 11A, respectively, and of the SOC 1250 of FIG. 12A. The SMPS 1220-d through 1220-f may be examples of the SMPS 1220-a through 1220-c of FIG. 12A.

The following expressions describe the power analysis associated with the dynamic voltage adjusting using SMPSs 1220-d through 1220-f and respective LDOs 1260-a through 1260-c (e.g., indirect scaling):

V_{SCALED}=V_{LDO}

I_{LOAD}=C×V_{LDO}×F+I_{BIAS}

I_{BATT}=I_{LOAD}×(V_{SMPS}/V_{BATT})×(1/e)

P=V_{BATT}×I_{BATT}

where some of these terms are common to those described above for the analysis with respect to FIG. 12A. Moreover, V_{LDO}=output of the LDO and I_{BIAS}=LDO bias current. The power calculations may be as follows:

Power before scaling: (C×F)×(V_{SMPS})²×(1/e)

Power after scaling: (C×F)×(V_{SCALED})×(V_{SMPS})×(1/e) (not including LDO bias current)

Power after scaling: (V_{SMPS})×(C×F×V_{SCALED}+I_{BIAS})×(1/e) (including LDO bias current)

In an example that provides comparison between the implementation of the device 1210 and the device 1210-a in FIG. 12A and FIG. 12B, respectively, the following assumptions may be made:

V_{BATT}=3.6 V

V_{SMPS}=1.05 V

V_{SCALED}=0.8 V

I_{BIAS}=50 μA

e(fficiency)=0.9

C×F=10⁻³

Nominal block current=C×F×V_{SMPS}=C×F×(1.05 V)

Under these conditions, the calculated power without the use of DVFS may be 12.25 mW. The calculated power when DVFS and direct scaling (e.g., SMPS as shown in FIG. 12A) are used may be 7.1 mW, approximately a 42% reduction in the amount of power used. The calculated power when DVFS and indirect scaling (e.g., SMPS/LDO as shown in FIG. 12B) are used and the LDO bias is ignored may be 9.33 mW, approximately a 24% reduction in the amount of power used. The calculated power when DVFS and indirect scaling (e.g., SMPS/LDO as shown in FIG. 12B) are used and the LDO bias is included may be 9.39 mW, approximately a 23% reduction in the amount of power used. From these results, direct scaling may be used to provide a larger reduction in the amount of power used. This approach may be easy to implement in an integrated solution with an external PMIC with multiple DVFS capable SMPSs. Indirect scaling, on the other hand, may be suitable in discrete (not integrated) solutions. Note that the voltage scaling outlined in FIG. 12A and FIG. 12B may be used to scale corresponding clock frequencies used for processing digital data.

The various techniques described herein for implementing dynamic voltage and/or frequency adjusting may also be applicable to wireless modems used in cellular communications such as those use in UEs for LTE networks. Below are provided some embodiments that implement features or aspects of dynamic voltage and/or frequency adjusting into LTE-based communications.

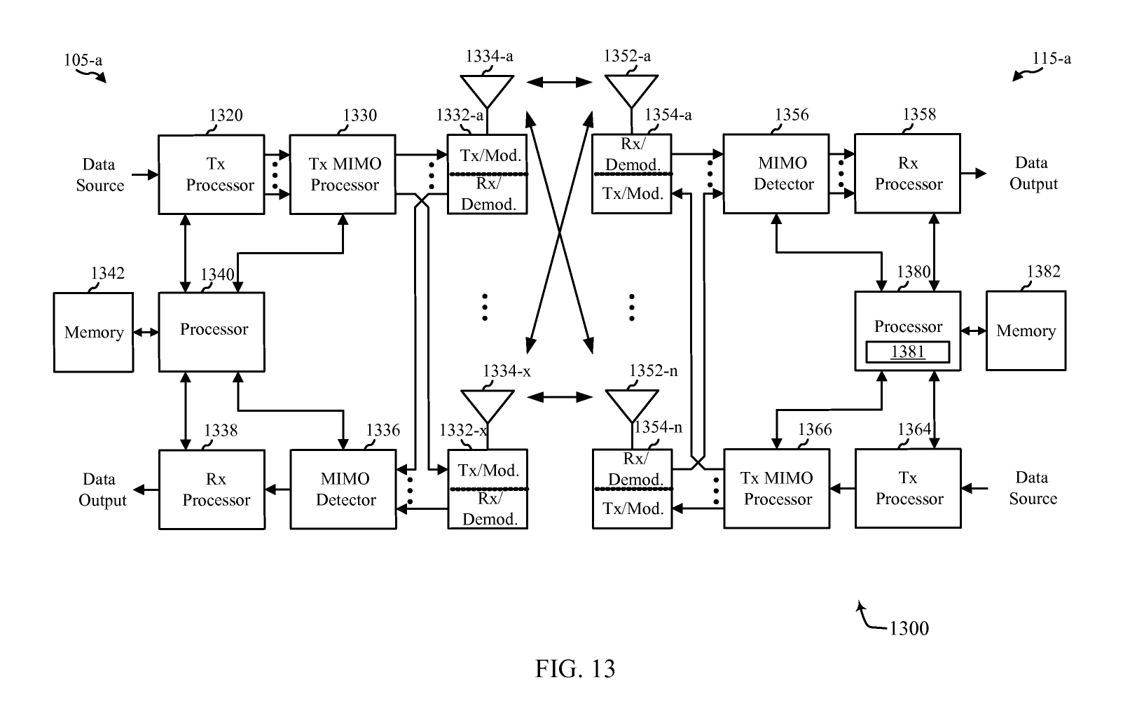

Turning to FIG. 13, a block diagram of a communication system 1300 is shown including a base station 105-a and a UE 115-b. The base station 105-a may be an example the base station 105 of FIG. 1. The UE 115-b may be an example of the user equipment 115 and/or 115-a of FIGS. 1 and/or 8. The communication system 1300 may illustrate aspects of the network of FIG. 1. The base station 105-a may be equipped with antennas 1334-a through 1334-x, and the UE 115-b may be equipped with antennas 1352-a through 1352-n. In the MIMO communication system 1300, the base station 105-a may be able to send data over multiple communication links at the same time. Each communication link may be called a “layer” and the “rank” of the communication link may indicate the number of layers used for communication. For example, in a 2×2 MIMO system where base station 105-a transmits two “layers,” the rank of the communication link between the base station 105-a and the UE 115-b is two.

At the base station 105-a, a transmit (Tx) processor 1320 may receive data from a data source. The transmit processor 1320 may process the data. The transmit processor 1320 may also generate reference symbols, and a cell-specific reference signal. A transmit (Tx) MIMO processor 1330 may perform spatial processing (e.g., precoding) on data symbols, control symbols, and/or reference symbols, if applicable, and may provide output symbol streams to the base station modulators 1332-a through 1332-x. Each base station modulator 1332 may process a respective output symbol stream (e.g., for OFDM, etc.) to obtain an output sample stream. Each base station modulator 1332 may further process (e.g., convert to analog, amplify, filter, and upconvert) the output sample stream to obtain a downlink (DL) signal. In one example, DL signals from base station modulators 1332-a through 1332-x may be transmitted via the antennas 1334-a through 1334-x, respectively.

At the UE 115-b, the antennas 1352-a through 1352-n may receive the DL signals from the base station 105-a and may provide the received signals to the UE demodulators 1354-a through 1354-n, respectively. Each UE demodulator 1354 may condition (e.g., filter, amplify, downconvert, and digitize) a respective received signal to obtain input samples. Each UE demodulator 1354 may further process the input samples (e.g., for OFDM, etc.) to obtain received symbols. A MIMO detector 1356 may obtain received symbols from all the UE demodulators 1354-a through 1354-n, perform MIMO detection on the received symbols if applicable, and provide detected symbols. A receive (Rx) processor 1358 may process (e.g., demodulate, deinterleave, and decode) the detected symbols, providing decoded data for the UE 115-b to a data output, and provide decoded control information to a processor 1380, or memory 1382. The processor 1380 may include a module 1381 that may perform functions related to dynamic voltage and frequency adjusting (e.g., in-subframe DVFS).

On the uplink (UL), at the UE 115-b, a transmit (Tx) processor 1364 may receive and process data from a data source. The transmit processor 1364 may also generate reference symbols for a reference signal. The symbols from the transmit processor 1364 may be precoded by a transmit (Tx) MIMO processor 1366 if applicable, further processed by the UE modulators 1354-a through 1354-n (e.g., for SC-FDMA, etc.), and be transmitted to the base station 105-a in accordance with the transmission parameters received from the base station 105-a. At the base station 105-a, the UL signals from the UE 115-b may be received by the antennas 1334, processed by the base station demodulators 1332, detected by a MIMO detector 1336 if applicable, and further processed by a receive processor. The receive (Rx) processor 1338 may provide decoded data to a data output and to the processor 1340 and/or memory 1342.

The components of the base station 105-a may, individually or collectively, be implemented with one or more ASICs adapted to perform some or all of the applicable functions in hardware. Each of the noted modules may be a means for performing one or more functions related to operation of the MIMO communication system 1300. Similarly, the components of the UE 115-b may, individually or collectively, be implemented with one or more ASICs adapted to perform some or all of the applicable functions in hardware. Each of the noted components may be a means for performing one or more functions related to operation of the MIMO communication system 1300.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. The MAC layer may perform priority handling and multiplexing of logical channels into transport channels. The MAC layer may also use Hybrid ARQ (HARM) to provide retransmission at the MAC layer to improve link efficiency. At the PHY layer, the transport channels may be mapped to Physical channels.

Turning next to FIG. 14, a flowchart is shown of an example method 1400 for wireless communication. The method 1400 may be performed using, for example, the user equipment 115, 115-a, and/or 115-b of FIG. 1, FIG. 8, and/or FIG. 13; the base station 105 and/or 105-a of FIG. 1 and/or FIG. 13; the device 200, 1110, 1110-a, 1200, and/or 1200-a of FIG. 2, FIG. 11A, FIG. 11B, FIG. 12A, and/or FIG. 12B; the DVFS module 840 of FIG. 8; and/or the transceiver module 850, 850-a, 850-b, 850-c, and/or 850-d of FIGS. 8, 9A, 9B, 10A, and/or 10B.

At block 1405, a wireless communication device (e.g., UE 115 or base station 105) may receive an allocation of physical resources (e.g., PRBs) to be utilized by the wireless communication device during one or more portions of a subframe. At block 1410, one or more bandwidths to be utilized at the wireless communication device during the one or more portions of the subframe may be determined (e.g., using the bandwidth determining module 834). The one or more bandwidths may be determined based on the received allocation of physical resources. At block 1415, at least one of a voltage level and/or a clock frequency of the wireless communication device may be adjusted (e.g., by the DVFS module 840) to process the one or more portions of the subframe. The at least one of voltage level and/or the clock frequency may be adjusted based on the determined one or more bandwidths.

In some embodiments of the method 1400, the allocation of physical resources may include an uplink grant, and the allocated physical resources may be utilized to transmit data during the one or more portions of the subframe while operating at the at least one of adjusted voltage level and/or clock frequency. In other embodiments of the method 1400, the allocated physical resources may be utilized to receive data during the one or more portions of the subframe while operating at the at least one of adjusted voltage level or clock frequency. The data received during the one or more portions of the subframe may also be processed at the at least one of adjusted voltage level or clock frequency.

In some embodiments of the method 1400, at least one of an analog front-end filter or a digital filter of the wireless communication device may be reconfigured based on the received allocation of physical resources. Reconfiguring an analog front-end filter may include changing a center frequency and bandwidth of the analog front-end filter based on the received allocation of physical resources. Reconfiguring the digital filter may include changing a bandwidth and down-mixing of the digital filter based on the received allocation of physical resources.

In some embodiments of the method 1400, a control region of the subframe may be received while operating the wireless communication device at a wideband mode across a system bandwidth defined for the subframe, and the allocation of physical resources to be utilized by the wireless communication device during the one or more portions of the subframe may be received over the control region of the subframe. In these embodiments, a reconfiguration of at least one of an analog front-end filter or a digital filter, based on the received allocation of physical resources, may occur between the control region of the subframe and the one or more portions of the subframe for which the allocation of physical resources is received.

In some embodiments of the method 1400, the method may include adjusting, based on the received allocation of physical resources, at least one of an analog domain clock, a digital domain clock, a sampling rate, or a size of a discrete Fourier transform or an inverse discrete Fourier transform utilized by the wireless communication device to process the one or more portions of the subframe.

In some embodiments of the method 1400, the adjusted voltage level may be applied to at least one of an analog front-end of the wireless communication device or a digital signal processing component of the wireless communication device. The digital processing component of the wireless communication device may include at least one of: a digital filter, a discrete Fourier transform component of the wireless communication device, an inverse discrete Fourier transform component of the wireless communication device, a digital signal processor of the wireless communication device, or a hardware accelerator.

In some embodiments of the method 1400, receiving the allocation of physical resources to be utilized by the wireless communication device during the one or more portions of the subframe may include receiving an identification of a number of physical resource blocks allocated to the wireless communication device, and determining the one or more bandwidths to be utilized at the wireless communication device during the one or more portions of the subframe may include adjusting a minimum bandwidth associated with the number of physical resource blocks allocated to the wireless communication device by a bandwidth adjusting factor.

In some embodiments of the method 1400, the method may include adjusting the voltage level of the wireless communication device during a measurement gap based on a bandwidth to be utilized at the wireless communication device during the measurement gap.

Turning next to FIG. 15, a flowchart is shown of an example method 1500 for wireless communication. The method 1500, like the method 1400 above, may be performed using, for example, the user equipment 115, 115-a, and/or 115-b of FIG. 1, FIG. 8, and/or FIG. 13; the base station 105 and/or 105-a of FIG. 1 and/or FIG. 13; the device 200, 1110, 1110-a, 1200, and/or 1200-a of FIG. 2, FIG. 11A, FIG. 11B, FIG. 12A, and/or FIG. 12B; the DVFS module 840 of FIG. 8; and/or the transceiver module 850, 850-a, 850-b, 850-c, and/or 850-d of FIGS. 8, 9A, 9B, 10A, and/or 10B.

At block 1505, a control region of a subframe may be received while operating a wireless communication device (e.g., UE 115 or base station 105) at a wideband mode across a system bandwidth defined for the subframe. At block 1510, the wireless communication device may receive an allocation of physical resources (e.g., PRBs) to be utilized by the wireless communication device during one or more portions of the subframe. At block 1515, a bandwidth to be utilized at the wireless communication device during the one or more portions of the subframe may be determined (e.g., using the bandwidth determining module 834). The bandwidth may be determined based on the received allocation of physical resources. At block 1520, the wireless communication device may adjust (e.g., using the DVFS module 840) from the wideband mode associated with receipt of the control region to a narrowband mode associated with utilization of the allocated physical resources. At block 1525, the allocated physical resources may be utilized during the one or more portions of the subframe to transmit or receive data in the narrowband mode.

In some embodiments of the method 1500, the allocation of physical resources to be utilized by the wireless communication device during the one or more portions of the subframe may be received over the control region of the subframe.

In some embodiments of the method 1500, the allocation of physical resources may include an uplink grant, and the allocated physical resources may be utilized at block 1525 to transmit data in the narrowband mode. In other embodiments of the method 1500, the allocated physical resources may be utilized at block 1525 to receive data in the narrowband mode. The received data may also be processed in the narrowband mode.

Turning next to FIG. 16, a flowchart is shown of an example method 1600 for wireless communication. The method 1600 may provide a way to accomplish the adjusting described with reference to block 1520 of the method 1500. The method 1600, like the methods 1400 and 1500 above, may be performed using, for example, the user equipment 115, 115-a, and/or 115-b of FIG. 1, FIG. 8, and/or FIG. 13; the base station 105 and/or 105-a of FIG. 1 and/or FIG. 13; the device 200, 1110, 1110-a, 1200, and/or 1200-a of FIG. 2, FIG. 11A, FIG. 11B, FIG. 12A, and/or FIG. 12B; the DVFS module 840 of FIG. 8; and/or the transceiver module 850, 850-a, 850-b, 850-c, and/or 850-d of FIGS. 8, 9A, 9B, 10A, and/or 10B.

At block 1605, an analog stage filter of a wireless communication device (e.g., UE 115 or base station 105) may be reconfigured based on a determined bandwidth (e.g., the bandwidth determined at block 1515 of the method 1500). At block 1610, a first voltage level associated with the wideband mode may be adjusted to a second voltage level based on the determined bandwidth. At block 1615, a size of an FFT block may be adjusted based on the determined bandwidth. At block 1620, a clock frequency (e.g., an analog domain clock) may be adjusted based on the determined bandwidth.

Turning next to FIG. 17, a flowchart is shown of an example method 1700 for wireless communication. The method 1700 may provide another way to accomplish the adjusting described with reference to block 1520 of the method 1500. The method 1600, like the methods 1400, 1500, and 1600 above, may be performed using, for example, the user equipment 115, 115-a, and/or 115-b of FIG. 1, FIG. 8, and/or FIG. 13; the base station 105 and/or 105-a of FIG. 1 and/or FIG. 13; the device 200, 1110, 1110-a, 1200, and/or 1200-a of FIG. 2, FIG. 11A, FIG. 11B, FIG. 12A, and/or FIG. 12B; the DVFS module 840 of FIG. 8; and/or the transceiver module 850, 850-a, 850-b, 850-c, and/or 850-d of FIGS. 8, 9A, 9B, 10A, and/or 10B.

At block 1705, a digital filter of a first digital stage of a wireless communication device (e.g., UE 115 or base station 105) may be reconfigured based on a determined bandwidth (e.g., the bandwidth determined at block 1515 of the method 1500). At block 1710, a second digital stage of the wireless communication device may be adjusted from a first voltage level associated with the wideband mode may be adjusted to a second voltage level based on the determined bandwidth. At block 1715, a size of an FFT block of the second digital stage may be adjusted based on the determined bandwidth. At block 1720, a clock frequency (e.g., a digital domain clock) of the second digital stage may be adjusted based on the determined bandwidth.

Turning next to FIG. 18, a flowchart is shown of an example method 1800 for wireless communication. The method 1800, like the methods 1400, 1500, 1600, and 1700 above, may be performed using, for example, the user equipment 115, 115-a, and/or 115-b of FIG. 1, FIG. 8, and/or FIG. 13; the base station 105 and/or 105-a of FIG. 1 and/or FIG. 13; the device 200, 1110, 1110-a, 1200, and/or 1200-a of FIG. 2, FIG. 11A, FIG. 11B, FIG. 12A, and/or FIG. 12B; the DVFS module 840 of FIG. 8; and/or the transceiver module 850, 850-a, 850-b, 850-c, and/or 850-d of FIGS. 8, 9A, 9B, 10A, and/or 10B.

At block 1805, a control region of a subframe may be received while operating a wireless communication device (e.g., UE 115 or base station 105) at a wideband mode across a system bandwidth defined for the subframe. At block 1810, and based on the control region of the subframe, a downlink grant for the wireless communication may be determined. The downlink grant may be associated with a downlink portion of the subframe and may include an allocation of physical resources (e.g., PRBs) to be utilized by the wireless communication device for transmitting data during the downlink portion of the subframe. At block 1815, a bandwidth to be utilized at the wireless communication device during the downlink portion of the subframe may be determined (e.g., using the bandwidth determining module 834). The bandwidth may be determined based on the allocation of physical resources included in the downlink grant, and may be selected from among multiple bandwidths supported by the wireless communication device. At block 1820, the wireless communication device may identify a voltage level or clock frequency to use for the determined bandwidth. At block 1825, the wireless communication device may adjust (e.g., using the DVFS module 840) a current voltage level or clock frequency to the voltage level or clock frequency identified at block 1820. At block 1830, at least a portion of the data in the downlink portion of the subframe may be received and processed at the adjusted voltage level or clock frequency.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, instructions, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media. Any combination of one or more non-transitory computer readable medium(s) may be utilized. Non-transitory computer-readable media comprise all computer-readable media, with the sole exception being a transitory, propagating signal.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein; the disclosure is to be accorded the widest scope consistent with the principles and novel features disclosed herein.

What is claimed is:

1. A method for wireless communication, comprising:
receiving at a wireless communication device an allocation of physical resources to be utilized by the wireless communication device during one or more portions of a subframe;
determining one or more bandwidths to be utilized at the wireless communication device during the one or more portions of the subframe based on the received allocation of physical resources; and
adjusting at least one of a voltage level or a clock frequency of the wireless communication device to process the one or more portions of the subframe, wherein the at least one of the voltage level or the clock frequency is adjusted based on the determined one or more bandwidths.

2. The method of claim 1, wherein the allocation of physical resources comprises an uplink grant, the method further comprising:
transmitting data during the one or more portions of the subframe while operating at the at least one of adjusted voltage level or clock frequency.

3. The method of claim 1, further comprising:
receiving data during the one or more portions of the subframe while operating at the at least one of adjusted voltage level or clock frequency; and
processing data received during the one or more portions of the subframe at the at least one of adjusted voltage level or clock frequency.

4. The method of claim 1, further comprising:
reconfiguring at least one of an analog front-end filter or a digital filter of the wireless communication device based on the received allocation of physical resources to be utilized by the wireless communication device during the one or more portions of the subframe.

5. The method of claim 4, wherein at least one of:
reconfiguring the analog front-end filter comprises changing a center frequency and bandwidth of the analog front-end filter based on the received allocation of physical resources to be utilized by the wireless communication device during the one or more portions of the subframe; or
reconfiguring the digital filter comprises changing a bandwidth and down-mixing of the digital filter based on the received allocation of physical resources to be utilized by the wireless communication device during the one or more portions of the subframe.

6. The method of claim 4, further comprising:
receiving a control region of the subframe while operating the wireless communication device at a wideband mode across a system bandwidth defined for the subframe;
wherein the reconfiguration of the analog front-end filter or the digital filter occurs between the control region of the subframe and the one or more portions of the subframe; and
wherein the allocation of physical resources to be utilized by the wireless communication device during the one or more portions of the subframe is received over the control region of the subframe.

7. The method of claim 1, further comprising:
adjusting, based on the received allocation of physical resources to be utilized by the wireless communication device during the one or more portions of the subframe, at least one of an analog domain clock, a digital domain clock, a sampling rate, or a size of a discrete Fourier transform or an inverse discrete Fourier transform utilized by the wireless communication device to process the one or more portions of the subframe.

8. The method of claim 1, further comprising:
applying the adjusted voltage level to at least one of an analog front-end of the wireless communication device or a digital signal processing component of the wireless communication device; wherein the digital signal processing component of the wireless communication device comprises at least one of: a digital filter, a discrete Fourier transform component of the wireless communication device, an inverse discrete Fourier transform component of the wireless communication device, a digital signal processor of the wireless communication device, or a hardware accelerator.

9. The method of claim 1, wherein:
receiving the allocation of physical resources to be utilized by the wireless communication device during the one or more portions of the subframe comprises receiving an identification of a number of physical resource blocks allocated to the wireless communication device; and
determining the one or more bandwidths to be utilized at the wireless communication device during the one or more portions of the subframe comprises adjusting a minimum bandwidth associated with the number of physical resource blocks allocated to the wireless communication device by a bandwidth adjusting factor.

10. The method of claim 1, further comprising:
adjusting the voltage level of the wireless communication device during a measurement gap based on a bandwidth to be utilized at the wireless communication device during the measurement gap.

11. A wireless communication device apparatus, comprising:
at least one processor; and
a memory communicatively coupled with the at least one processor, the memory storing instructions configured to cause the at least one processor to:
receive an allocation of physical resources to be utilized by the wireless communication device apparatus during one or more portions of a subframe;
determine one or more bandwidths to be utilized at the wireless communication device apparatus during the one or more portions of the subframe based on the received allocation of physical resources; and
adjust at least one of a voltage level or a clock frequency of the wireless communication device apparatus to process the one or more portions of the subframe, wherein the at least one of voltage level or the clock frequency is adjusted based on the determined one or more bandwidths.

12. The wireless communication device apparatus of claim 11, wherein the allocation of physical resources comprises an uplink grant, and wherein the instructions are further configured to cause the at least one processor to:
transmit data during the one or more portions of the subframe while operating at the at least one of adjusted voltage level or clock frequency.

13. The wireless communication device apparatus of claim 11, wherein the instructions are further configured to cause the at least one processor to:
receive data during the one or more portions of the subframe while operating at the at least one of adjusted voltage level or clock frequency; and
process the data received during the one or more portions of the subframe at the adjusted voltage level or clock frequency.

14. The wireless communication device apparatus of claim 11, wherein the instructions are further configured to cause the at least one processor to:
reconfigure at least one of an analog front-end filter or a digital filter of the wireless communication device apparatus based on the received allocation of physical resources to be utilized by the wireless communication device apparatus during the one or more portions of the subframe.

15. The wireless communication device apparatus of claim 14, wherein at least one of:
the instructions configured to cause the at least one processor to reconfigure the analog front-end filter comprise instructions configured to cause the at least one processor to change a center frequency and bandwidth of the at least one analog front-end filter based on the received allocation of physical resources to be utilized by the wireless communication device apparatus during the one or more portions of the subframe; or
the instructions configured to cause the at least one processor to reconfigure the digital filter comprise instructions configured to cause the at least one processor to change a bandwidth and down-mixing of the at least one digital filter based on the received allocation of physical resources to be utilized by the wireless communication device apparatus during the one or more portions of the subframe.

16. The wireless communication device apparatus of claim 14, wherein:
the instructions are further configured to cause the at least one processor to receive a control region of the subframe while operating the wireless communication device apparatus at a wideband mode across a system bandwidth defined for the subframe;
the reconfiguration of the analog front-end filter or the digital filter of the wireless communication device apparatus occurs between the control region of the subframe and the one or more portions of the subframe; and
the allocation of physical resources to be utilized by the wireless communication device apparatus during the one or more portions of the subframe is received over the control region of the subframe.

17. The wireless communication device apparatus of claim 11, wherein the instructions are further configured to cause the at least one processor to:
adjust, based on the received allocation of physical resources to be utilized by the wireless communication device apparatus during the one or more portions of the subframe, at least one of an analog domain clock, a digital domain clock, a sampling rate, or a size of a discrete Fourier transform or an inverse discrete Fourier transform utilized by the wireless communication device apparatus to process the one or more portions of the subframe.

18. The wireless communication device apparatus of claim 11, wherein the instructions are further configured to cause the at least one processor to:
apply the adjusted voltage level to at least one of an analog front end of the wireless communication device apparatus or a digital signal processing component of the wireless communication device apparatus; wherein the digital signal processing component of the wireless communication device apparatus comprises at least one of: a digital filter, a discrete Fourier transform component of the wireless communication device apparatus, an inverse discrete Fourier transform component of the wireless communication device apparatus, a digital signal processor of the wireless communication device apparatus, or a hardware accelerator.

19. The wireless communication device apparatus of claim 11, wherein:
receiving the allocation of physical resources to be utilized by the wireless communication device apparatus during the one or more portions of the subframe comprises receiving an identification of a number of physical resource blocks allocated to the wireless communication device apparatus; and
determining the one or more bandwidths to be utilized at the wireless communication device apparatus during the one or more portions of the subframe comprises adjusting a minimum bandwidth associated with the number of physical resource blocks allocated to the wireless communication device apparatus by a bandwidth adjusting factor.

20. The wireless communication device apparatus of claim 11, wherein the instructions are further configured to cause the at least one processor to:
adjust the voltage level of the wireless communication device apparatus during a measurement gap based on a bandwidth to be utilized at the wireless communication device apparatus during the measurement gap.
